(19) United States
(12) Patent Application Publication
(10) Pub. No.: US 2022/0006661 A1
(43) Pub. Date: Jan. 6, 2022

(54) Access and communicate live audio streaming under micro channel or keyword(s)

(71) Applicant: Yogesh Rathod, Mumbai (IN)

(72) Inventor: Yogesh Rathod, Mumbai (IN)

(21) Appl. No.: 17/265,210

(22) PCT Filed: Jul. 11, 2015
(86) PCT No.: PCT/IB2015/055252

§ 371 Date: Feb. 2, 2021

(30) Foreign Application Priority Data
Jul. 27, 2014 (IB) PCT/IB2014/063461

(51) Int. Cl. H04L 12/18; G06F 16/58; G06F 16/68; G06F 16/78; G06F 16/9035

(52) U.S. Cl. CPC H04L 12/1818; H04L 12/1822; H04L 12/1831; G06F 16/9035; G06F 16/686; G06F 16/7867; G06F 16/5866

(57) ABSTRACT

Various embodiments of a system, methods, server, client, and graphical user interface for creating micro channel or keyword(s) and associating settings in response to receiving request to create micro channel or keyword(s) with associated settings, wherein associated settings comprises allow one or more contacts, invited users or invitation accepted users, followers, any or all or part of users of network to communicate live audio streaming under said created micro channel or keyword(s) or access communicated live audio streaming under said created micro channel or keyword(s), receiving request from micro channel or keyword(s) related users including creator of micro channel or keyword(s) and associated allowed users to communicate live audio streaming under selected micro channel or keyword(s) and communicating live audio streaming to micro channel or keyword(s) for enabling micro channel or keyword(s) related users to access related live audio streaming.

### FIELD OF INVENTION

The present invention relates generally to enabling a user to user micro-channels for posting and viewing contextual live contents in real-time. The present invention also relates generally to presenting various types or formats of contents, data, resources & multimedia to contextual viewers including real-time generated, related, provided, published, presented, broadcasted & shared user generated various types of contents or keyword(s), key phrase(s), categories & taxonomies specific contents to various types of contextual viewers including contacts, connections, followers or subscribers, preferred, requested, targeting criteria specific, matched or likeminded or similar interest users or viewers readers or audience. The present invention relates generally to enabling user(s) to select, input, capture, edit, update, compose, collaboratively draft, collect, aggregate and share, post, sent, publish, synchronize & provide one or more or group(s) of selected, created, inputted, updated, verified, collaboratively created & updated keywords, key phrases, categories, types, ontology, taxonomies and any combination thereof specific one or more types of structures and/or un-structured contents including text, photo, image, audio, voice, video, link, file, object, application and one or more types of media to contextual viewers or receivers or users or followers of contextual one or more keywords, key phrases, named entities, nodes, categories, types, ontology, taxonomies and any combination thereof. The present invention relates generally to presenting shared contents to target viewers and enabling to provide & follow or auto follow or real-time request keyword(s) specific contents.

### BACKGROUND OF THE INVENTION

At present QIK, Snapchat, Periscope, Market, Ustreams & other live streams enable users to broadcast streaming video, streaming audio to user's contacts and followers. But none of the above enables a user-to-user micro-channels for posting and viewing contextual live contents as and when they broadcasted or posted or shared. Television or other sources provide pre-created contents at a particular scheduled time. Present invention enables users of networks to post or broadcast contents under particular micro-channels for real-time making them available for other users of the network as and when they broadcasted by users of the network. So viewing users are enabled to continuously view a series of contextual contents as and when they broadcasted or posted. They can auto save and view later locally or they can pause for some time and view within that period or skip come contents to view next preferred contents. Users can also jump or preview & jump or filter & jump or jump on most viewed or liked live broadcasted contents items. Users have a total 24 hours a day to view preferred contents, so present invention enables utilization of user's time in the best way and presents the most recently broadcasted contextual, most viewed or liked & updated contents as and when they broadcasted or posted or shared.

At present Wikipedia enables users to collaboratively provide, edit, compose & update particular subject and topic specific user generated contents and enable users to search and view said collaboratively created & updated subject and topic specific user generated contents. Quora enables users to collaboratively provide, edit, compose & update particular question(s) specific various answers. Twitter enables users to post or share contents to followers and connected users or contacts. Users have to create a base of followers, which is time consuming and uncertain. Facebook newsfeed enables users to automatically post or present contents of a user to connected users of the user. WhatsApp and other messaging app enable users to share contents to selected contacts of users. Conventional system does not enable users to post one or more or group(s) of selected, created, inputted, updated, verified, collaboratively created & updated keywords, key phrases, categories, types, ontology, taxonomies and any combination thereof specific one or more types of structures and/or unstructured contents to followers and follow one or more or group(s) of keywords, key phrases, categories, types, ontology, taxonomies and any combination thereof for real-time receiving contents.

Collectively user generated similar or contextual contents real-time present to contextual viewers, so publishers can instantly attract traffics or viewership. Users of the network can set, define, select, input, apply and provide preferences for viewing or receiving types of contents from the plurality of users of the network. Present invention enables instant creation of followers and viewer base. Quality posts can attract large amounts of followers and viewers instantly.

Sever matches receives one or more or group(s) of keywords, key phrases, categories, types, ontology, taxonomies and any combination thereof specific one or more types of structures and/or un-structured contents of posting or sharing users and real-time present to followers of one or more or group(s) of exact and/or broad matched and/or similar keywords, key phrases, categories, types, ontology, taxonomies and any combination thereof.

Therefore, it is with respect to these considerations and others that the present invention has been made.

### OBJECT OF THE INVENTION

The principal object of the present invention is to enable user-to-user micro-channels for posting and viewing contextual live contents. Users can continually notify & view available contextual live contents as and when they are posted by other users of the network. Contents presented as per they posted or most liked within a particular duration of time period. So, viewers always get new & updated contextual contents and view more contents.

The object of the present invention is to enable a user to pause for viewing a live series of broadcasted & received contents for a particular period of time. Users can skip some live broadcasted contents in queue or fast forward received broadcasted contents to view real-time broadcasted contents up-to reaching of last live broadcasted contents.

The object of the present invention is to enabling user(s) to select, input, capture, edit, update, compose, collaboratively draft, collect, aggregate and share, post, sent, publish, synchronize & provide one or more or group(s) of selected, created, inputted, updated, verified, collaboratively created & updated keywords, key phrases, categories, types, ontology, taxonomies and any combination thereof specific one or more types of structures and/or un-structured contents including text, photo, image, audio, voice, video, link, file, object, application and one or more types of media to contextual viewers or receivers or users or followers of contextual one or more exact and/or broadly matched and/or similar keywords, key phrases, named entities, nodes, categories, types, ontology, taxonomies and any combination thereof.

The other object of the present invention is to enabling user to post structured contents and post interactive forms, form including defined fields and associate values, custom forms, interfaces, applications, objects, widgets, web pages, web sites, part of web sites, features, controls, links to keyword specific followers and contextual viewers to enabling them to take one or more user actions including fill-up forms and send to provider of form(s), download job profile, buy products, subscribe services, participate in deals, compare products, job profile & offers and like.

The other object of the present invention is to facilitate and suggest user(s) in what to post including suggest types of posts or shared contents which attracts viewers and how & where to get contents for posting including provide directories, list of categories of sources of contents including web sites, web pages or features, database and like, so user can search, match, read, learn, abstract, edit & draft new user generated contents for posting to contextual keyword specific followers or viewers, where to post including which appropriate and contextual one or more exact and/or broadly matched and/or similar types of keywords, key phrases, named entities, nodes, categories, types, ontology, taxonomies and any combination thereof in which user can post his/their current post, when to post including alerting or remembering or suggesting user to post one or more types of contents based on date, time, user activities, actions, events, transactions, logs, interactions, senses, locations, check-in places, updates, status, current trends, connections, connected users' data, user profile, preferences, privacy settings, shared data & any combination thereof, how to post, why to post, whom to post, how to improve quality of post for attracting more viewers & how to attract more viewers.

The other object of the present invention is to enable users to collaboratively input, edit, and update one or more types of contents and posting to followers and/or contextual viewers, wherein collaboration based on invitation, accepting request, add to one or more types of group(s).

The other object of the present invention is to enabling user to create, draft, compose, collect, aggregate, compile, order, apply presentation styles & privacy settings, format one or more or group(s) or series of post(s) and posting to one or more exact and/or broadly matched and/or similar types of keywords, key phrases, named entities, nodes, categories, types, ontology, taxonomies and any combination thereof specific followers and/or contextual viewers.

The other object of the present invention is to create base of multidimensional or multiple types of one or more exact and/or broadly matched and/or similar types of keywords, key phrases, named entities, nodes, categories, types, ontology, taxonomies and any combination thereof specific contents for followers or contextual viewers including structured including forms, fields and associate values, application specific contents, structured database, unstructured contents, various types of media including text, photo, image, audio, voice, video, link, file, object, application and one or more types of media, questions and associate answers, interactive surveys, micro blogging or blogs, news, articles, curated or ranked search results and like.

The other object of the present invention is to instructing, asking, suggesting posting users and viewers or followers to provide more details related to posted contents to enhance details of posted contents including establishing chat session among provider and/or viewers and/or followers to contribute and collaboratively provide contents, contents based on suggested fields like availability of product, features of product, alternatives, profile, curated contents from web or other sources, associate questions and answers, news, associate metadata, keywords, tags, & links, user actions like indication of purchase or use or experience of products & services.

The other object of the present invention is to auto follow or auto receive contents based on preferences and matched user data, wherein user data comprises user profile, user connections, connected users' data, user shared data or contents, user logs, activities, actions, events, senses, transactions, status, updates, presence information, locations, check-in places, privacy settings and like.

The other object of the present invention is to enabling user to search, match, select & follow one or more or group(s) of exact and/or broadly matched and/or similar types of keywords, key phrases, named entities, nodes, categories, types, ontology, taxonomies and any combination thereof for real time receiving current, updated & posted various types of contents.

The other object of the present invention is to instantly create followers and viewer base.

The other object of the present invention is to post and receive contextual & quality or ranked contents. User have option to receive contents without following other users of network i.e. no need to make followers, best contents drive and attracts more instant viewers.

The other object of the present invention is to enable users to receive shared contents without creating a follower base based on selected, set, updated & provided preferences.

The other object of the present invention is to enhance sharing or viewing of contents due to the possibility of instant attracting of followers & viewers. Posting users always want that his post may be viewed by more users, more times and like & rate post by more viewers & get more comments.

The other object of the present invention is to enable posting users to prepare and post more popular contextual keyword(s) or key phrase(s) specific contents.

The other object of the present invention is to enabling user to pre-create or update list of keywords, key phrases, categories or taxonomies under that one or more selected keywords, key phrases, categories or taxonomies user can post or share or publish one or more types of contents including message, blog, micoblog, article, notes, news, advertisement, one or more types of media including text, link, video, audio, voice, image, photo, document, file, object, application and ant types of digital contents or resources. Users can select, input, update, assign, associate, apply one or more keywords, key phrases, categories or taxonomies with one or more types of drafted, inputted, selected, searched, updated, edited, saved, collaboratively updated, posted, shared, captured & published contents.

The other important object of the present invention is to real time broadcasting categorized user generated contents to prospective, matched & contextual viewers based on preferences and matched user data of users, wherein user data comprises user profile, user connections, connected users' data, user shared data or contents, user logs, activities, actions, events, senses, transactions, status, updates, presence information, locations, check-in places and like.

The other object of the present invention is to instantly create a viewership base of shared contents.

The other object of the present invention is to post and receive contextual & quality or ranked contents. Users have the option to receive content without following other users of the network i.e. no need to make followers, best contents drive and attract more instant viewers.

The other object of the present invention is to enable users to receive shared contents without creating follower base based on selected, set, updated & provided preferences.

The other object of the present invention is to enhance sharing or viewing of contents due to possibility of instant attracting of followers & viewers. Posting users always want that his post may be viewed by more users, more times and like & rate post by more viewers & get more comments.

### DETAIL DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “receiving” posting or shared contents & communication and any types of multimedia contents from a device or component includes receiving the shared or posted contents & communication and any types of multimedia contents indirectly, such as when forwarded by one or more other devices or components. Similarly, “sending” shared contents & communication and any types of multimedia contents to a device or component includes sending the shared contents & communication and any types of multimedia contents indirectly, such as when forwarded by one or more other devices or components.

As used herein, the term “client application” refers to an application that runs on a client computing device. A client application may be written in one or more of a variety of languages, such as ‘C’, ‘C++’, ‘C #’, ‘J2ME’, Java, ASP.Net, VB.Net and the like. Browsers, email clients, text messaging clients, calendars, and games are examples of client applications. A mobile client application refers to a client application that runs on a mobile device.

As used herein, the term “network application” refers to a computer-based application that communicates, directly or indirectly, with at least one other component across a network. Web sites, email servers, messaging servers, and game servers are examples of network applications.

Briefly stated, the present invention is directed towards enabling users to post contents including live stream, photo, video, audio, text, one or more types of digital media or data & any combination thereof under one or more pre-defined channels or suggest type of channels for posting said contents. Present invention also enables users to view, access, follow or subscribe one or more said predefined channels for live viewing said channels specific contents, wherein said pre-defined channels may be created and suggested by users of the network. In an embodiment contextual or prospective viewers of said channels notify about new contents posted under said channels by users of the network. Viewing users can provide one or more ratings or rankings or points or likes to contents. In an embodiment more viewed contents presented in prioritize order, so it can attract more viewers. In an embodiment viewers can also provide tags, keywords and categories to viewed contents, so contents can also be available for other contextual or related channels. In an embodiment posted or broadcasted contents available live or only for a particular preset period of duration. In an embodiment posting user can show or hide identity. In an embodiment present invention enables live newsfeed wherein all contacts of posting user automatically notifies in real-time about new contents posted by user and in the event of acceptance present live stream or posted contents in real-time. In another important embodiment presented live contents also comprises contextual user actions including like, buy, sell, order, book, refer, subscribe, ask queries etc. In another embodiment auto present live contents based on most viewed, most liked, user's channel preferences, activities, actions, events, transactions, locations or check-in places and profile. Users can continually notify & view available contextual live contents as and when they are posted by other users of the network. Contents presented as per they posted or most liked within a particular duration of time period. So, viewers always get new & updated contextual contents and view more contents. Users can also save or re-share or access liked contents locally or at any storage medium as per permission provided or set by the broadcaster. In an embodiment user can real-time view more than one broadcasted contents at a time. In an embodiment enabling server to receive broadcasted or posted contents from users of network and process, format, delay broadcast or randomly broadcast to selected number or set—particular number of users or most viewing or most active viewers related to particular micro-channel(s) of network for identifying quality contents i.e. not necessary that all real-time posted or broadcasted contents received by all viewers at same fashion, some user view other while others can view other contents in same micro-channels. In another embodiment if less content in particular micro-channel queue then present it in near real-time.

In an embodiment method & system for enabling user to user live broadcasting or live sharing or live viewing comprising: enabling broadcasting and sharing user to broadcast or share or send or post one or more types of media including live stream, text, voice, photo & video under one or more selected pre-defined micro channels; enabling viewing user to access or set auto select mode to view or select or subscribe one or more said pre-defined micro channels to receive & view said broadcasted or shared or posted media or contents; and enabling viewing user to view said posted or broadcasted contents as and when they posted or broadcasted or enabling to real-time notify or real-time view or real-time view after acceptance of notification or view within particular duration said auto selected or preferred or most liked or subscribed one or more pre-defined micro channels specific one or more types of media including live stream, text, voice, photo & video from one or more broadcasters or sharing or posting users of network.

Briefly stated, the present invention is also directed towards presenting shared contents to target contextual viewers and enabling users to provide & follow or auto follow or real-time request exact, broader to narrow matched & similar keyword(s), key phrase(s), nodes, named entities, categories & taxonomies specific real time generated or provided or shared or posted or published contents.

In one embodiment present invention enabling user(s) to input, select, edit, update & verify one or more keyword(s), wherein keyword enables posting users of network to select verified keywords at the time of posting contents under said keyword; enabling user(s) to follow one or more keyword(s) for real-time receiving followed keyword(s) related posted contents; enabling user(s) to post contents under one or more keyword(s); store contents and associate keyword(s); matching followed keyword(s) of user(s) with said posted contents associate keyword(s); and presenting followed keyword(s) specific contents to keyword(s) follower(s).

In an embodiment keyword(s) comprises one or more or group(s) of exact, matched, broader matched, alternative, similar keywords, sequence of words or characters, categories, sub-categories, taxonomies, names, named entities, nodes, items, locations, key phrases, ontology, semantic syntax, sentence.

In an embodiment keyword matched based on exact match, broader match, narrow match, phrase match and similar matches.

In an embodiment enabling viewing users to follow one or more keyword(s) associate followers.

In an embodiment enabling viewing users to follow posted content associated viewers.

In an embodiment enabling viewing users to follow posted content source(s).

In an embodiment enabling viewing users to follow one or more followed keyword(s) related similar or alternative or matched other keyword(s).

In an embodiment enabling viewing users to ignore one or more received posted contents associate keyword(s).

In an embodiment enabling viewing users to ignore one or more received posted contents associate source(s).

In an embodiment enabling users to create and update list(s) of keyword(s).

In an embodiment enabling users to follow said one or more list(s) of keyword(s).

In an embodiment enabling users to follow said one or more keywords from said one or more list(s) of keyword(s).

In an embodiment enabling users to follow said one or more followers of said one or more list(s) of keyword(s).

In an embodiment creating group(s) based on posting users and/or followers of similar types of keywords including exact, broader match, phrase match, alternative, related meaning associate keywords, rank, number of likes & comments and ratings, similar profiles, activities, actions, events, transactions, locations, check-in places, updates, status, presence information, connections, connected users' data and any combination thereof.

In an embodiment enabling or instructing or suggesting said group(s) to share contents, enhance or expand posts, update posts, converse with each other.

In an embodiment enabling users to share and refer one or more keywords for enabling receiving users to follow said shared or referred keywords.

In an embodiment enabling posting users to target post to viewing users based on one or more criteria including locations, languages, IP addresses, user profile data or fields including age range, income range, education qualifications, user attributes including height, weight, color & like, cast, interests, preferences, privacy settings, rules, date & time, names, contacts, named entities, gender, employment type, business type, networks, type of user's activities, actions, events, senses, transactions, behavior, status and one or more or group(s) or list(s) of exact, broader matched, phrase match & similar keywords, key phrases, named entities, categories, & taxonomies associate followers & viewers and any combination thereof.

In an embodiment enabling to one or more keyword(s) specific posting users to follow each other and create group(s).

In an embodiment enabling to collaboratively draft, compose, input, edit, admin, update one or more posts and share contents.

In an embodiment enabling users to schedule posting and schedule presenting.

In an embodiment enabling user to select, start, pause, re-start, hide, show & stop or un-follow receiving of followed keyword(s) specific contents.

In an embodiment enabling the user to search, match, select and invite users of network and/or searched posts or contents associated sources, viewers, followers & following users to follow user or searching user.

In an embodiment enabling users to search, match, select posted contents and follow selected posted content associate keyword(s).

In an embodiment presenting to users matched & updated users related to users.

In an embodiment presenting to user matched & updated users related to user based on preferences, privacy settings, rank or rating of user, number of current points, purchasing of target or contextual viewers, user connections, followers, following users, viewers, related or contextual exact, broader matched, phrase match, similar & matched keyword specific posting users, groups, followers, following users & viewers, profile, shared contents, user activities, logs, actions, events, interactions, senses, transactions, locations, checked-in places, behavior.

In an embodiment enabling user to searching, matching, browsing, selecting users from presented matched & updated users related to user for inviting them to become followers of each other by accepting invitations.

In an embodiment enabling users to apply settings for automatically un-follow mutually followed users when mutually followed user(s) un-follow to user(s).

In an embodiment enabling users to follow one or more selected keywords of one or more source(s) or user(s) or posting user(s) or publisher(s) or broadcaster(s).

In an embodiment enabling user to follow broader or parent keywords which includes child or child of child up-to tree like presented number of depths or set or collection or group(s) or list(s) of keywords including similar, related, curated, contextual, ontologically & semantically or meaning wise related keywords.

In an embodiment enabling the user to create a list(s) of keywords including parent keyword(s) and associate child keyword(s), practically or semantically or ontologically or meaning wise related.

In an embodiment verify keywords including check language, availability, meaning, similar, alternate, existence of keyword(s) and phrase(s).

In an embodiment verification task assigned to one or more ranked or verified users of network, administrator, verify & validate via software, web services, databases, online web sites, search engines.

In an embodiment auto identify, attach, associate, relate, store, present, update one or more keywords, phrases, named entities, nodes, nodes of network, categories, taxonomies, ontology, metadata related to drafted, saved, edited, presented, selected, updated, posting or posted contents.

In an embodiment present, update, identify suggested one or more keywords, phrases, named entities, nodes, nodes of network, categories, taxonomies, ontology, metadata related to drafted, saved, edited, presented, selected, updated, posting or posted contents.

In an embodiment said post specific suggested keywords, phrases, named entities, nodes, nodes of network, categories, taxonomies, ontology, metadata are based on contents of post or drafted or updated or edited or presented or shared contents, meaning, similar or related or contextual, suggested by connected users, user profile, user data, connections, followers, following users, viewers, connected users' data, user logs, activities, actions, events, transactions, interactions, senses, locations, check-in places, updates, status, current trends, preferences, privacy settings, shared data & any combination thereof.

In an embodiment enabling user to search, match, import, ask, browse, filter, select one or more suggested keywords for posting contents under said selected one or more keywords, phrases, named entities, nodes, nodes of network, categories, taxonomies, ontology, metadata.

In an embodiment enabling user to select one or more keywords, phrases, named entities, nodes, nodes of network, categories, taxonomies, ontology, metadata related to drafted, saved, edited, presented, selected, updated, posting or posted contents.

In an embodiment enabling users to create, collaboratively create & update one or more keywords, phrases, named entities, nodes, nodes of network, categories, taxonomies, ontology, metadata.

In an embodiment enabling to receive, store, present, update, associate contextual, updated & real-time user generated contents or user posted contents to one or more keywords, phrases, named entities, nodes, nodes of network, categories, taxonomies, ontology, metadata related to one or more types of contents via APIs.

In an embodiment enabling user to select or select from highlighted one or more keywords, phrases, named entities, nodes, nodes of network, categories, taxonomies, ontology, metadata from presented, searched, received one or more types of contents and presenting said selected or highlighted one or more keywords, phrases, named entities, nodes, nodes of network, categories, taxonomies, ontology, metadata specific user posted or updated contents.

In an embodiment contents comprising contents of web page(s) or web site(s), drafted or edit contents, contents of application(s) or database(s) and one or more types of media including text, link, audio, image, photo, video, voice, voice to text, text detected from images or videos, file, document, application, object, user profile, named entities, keywords, phrases, named entities, locations, nodes, nodes of network, categories, taxonomies, ontology, metadata.

In an embodiment enabling users to post contents to followers, viewers & connected users without selected one or more keywords, phrases, named entities, nodes, nodes of network, categories, taxonomies, ontology, metadata.

In an embodiment suggesting or indicating user what to post including suggest or present or update one or more types of contents, invited for collaboratively drafted topic or subject or keyword, topics, trends, news, links, links of sources of contents including web sites, databases, past shared contents, contents from network, social network, user & connected users' profile(s) & related data.

In an embodiment suggestion based on user drafted or inputted or selected or edited or updated or presented contents.

In an embodiment suggestion based on based on user profile including fields and associate values like qualification, age, gender, location, type & name of employment or college or school & interests, user data, connections, followers, following users, viewers, connected users' data, user logs, activities, actions, events, transactions, interactions, senses, locations, check-in places, updates, status, current trends, preferences, privacy settings, shared data & any combination thereof.

In an embodiment enabling to verified as well as anonymous user accounts, enterprise accounts, posts or shared contents, sources, publishers, following related keywords, key phrases, categories, taxonomies, lists, viewers, followers, following users, contacts or connections, provider of comments, ratings, & likes.

In an embodiment enabling users to search, match, select, select from presented or suggested or auto matched, purchase, update, and customize structured contents for posting structured contents.

In an embodiment structured contents or resources comprises domain or subject or keyword(s) or key phrase(s) specific forms, wizards, templates, fields and/or associate values, applications, custom forms, interfaces, widgets, set of controls, links, objects, functions, features, user actions, pre-created and/or customizable forms including profile, job requirements, job profile, survey forms, advertisements, group deals.

In an embodiment enabling user to import, export, store & index to database, data mine, download, upload, subscribe, submit or resubmit filled forms, participate with interactive survey forms, follow, view, sort, filter, rank, rate, bookmark, group, list, categories, search & match based on one or more criteria, compare, calculate, process, analyze structured contents or resources.

In an embodiment suggesting or instructing viewing users or followers to provide one or more types of structured or unstructured further details on one or more posts or shared contents.

In an embodiment one or more types of structured or unstructured further details on one or more posts or shared contents comprises questions, answers, availability including locations, address, maps & directions, features, climate, price, comparison, similar posts or contents, related keywords, key phrases, categories, taxonomies & metadata, types of contents, properties, attributes, pre-created, presents & customized fields and associate values, edited or updated version of contents, enhancement of contents including related news, blogs, search results, links, photos, videos and like, one or more types of user actions including like, dis-like, buy, sell, purchased, interested, suggest, refer, bookmark, response, comments, rank, rate, vote, listen, play, recipe, emoticons.

In an embodiment enabling keyword(s) or key phrase(s) specific viewers & followers to view real-time updated or posted or provided and past posts and shared contents.

In an embodiment enabling the user to select one or more parts of keyword(s) or key phrase(s) for creating, generating & updating one or more keyword(s) or key phrase(s).

In an embodiment parts of keyword(s) or key phrase(s) comprises one or more grammar part(s), keywords, categories, taxonomies, groups, types, items, objects, nodes, named entities, type of purposes, requirements, activities, actions, transactions, events, status, actors, profile properties, metadata, data, fields & values, rules, conditions, criteria & programming syntax, phases, words, sentences, templates, tags, ontology, semantic syntax, Boolean Operators (+, −, >, <, =etc.), commands, types of syntax including structured query language (SQL), user associate contacts, connections, nodes, named entities, selected one or more fields and associate values, date & time (ranges, from-to, calendar, schedule).

In an embodiment enabling user to select one or more posts or one or more types of posts or one or more types of or one or more exact, broader or narrow matched or phrase matched or similar keywords or key phrases or categories or taxonomies specific posts related participations including chat with followers, viewers & providers, receive questions for providing answers, review or edit or update or rectify posts, report, provide ratings, likes or dislikes & comments, participate in collaborative enhancement of suggested topics, participate in real-time conversations, provide structure information, add curated or searched or edited contents from one or more sources and provide requested or suggested or instructed or presented topic or query or subject specific information or contents and provide participation date and time, scheduling, presence information or availability user & one or more types of participations.

In another embodiment present invention enabling user to draft, prepare, search, select, input, capture, record, author, compose, edit, update one or more or group(s) of keyword(s) or key phrase(s) specific one or more types of contents; enabling user to real-time or near real-time post, send, publish, update, export, share, synchronize, advertise, broadcast, send, provide & present one or more types of contents; enabling users to real-time or near real-time consume, receive, store, import, subscribe, follow, search, retrieve, select & view one or more or group(s) of keyword(s) or key phrase(s) specific contextual or updated one or more types of contents.

In an embodiment enabling user to draft, prepare, search, select, input, capture, record, author, compose, edit, update and post, send, publish, update, export, share, synchronize, advertise, broadcast, send, provide & present and consume, receive, store, import, subscribe, follow, search, retrieve, select & view one or more or group(s) of keyword(s) or key phrase(s) specific one or more types of contents from one or more web sites, domains, web pages, applications, clients including smart client applications, servers, devices, databases, networks via APIs, web services and one or more types of communication interface.

In an embodiment one or more types of contents comprises message, blog, article, news, survey, data, search results, questions and associate answers, structured contents including database, fields & associate values, one or more types of controls, forms, contents input, select, compose, update via applications, widgets, custom forms & interfaces, one or more types of media including text, link, audio, image, photo, video, voice, voice to text, text detected from images or videos, file, document, application, object, user profile, named entities, keywords, phrases, named entities, locations, nodes, nodes of network, categories, taxonomies, ontology, metadata and any combination thereof.

In an embodiment users comprises sender, receiver, posting user, sharing user, user(s) or group(s) of users of social network, administrator, editor, author, group(s), service provider(s), follower, following user, connected user, user connections, connections of connections, publisher, subscriber, advertiser, broadcaster, viewer, audience, provider, presenter, database, storage medium, server, application, web site, web page, web service, repository, device, network and auto sources, destinations, consumers & providers.

In an embodiment enabling users to search, match, browse & select, highlight, select from suggested. select from presented, select from highlighted, share, suggest, update, edit, remove, sort, rank or rate, list or group or categories, bookmark, draft, identify, verify, validate, import, merge, divide, generate & create one or more keyword(s) or key phrase(s).

In an embodiment auto present or suggest one or more or group(s) or list(s) of keyword(s) or key phrase(s).

In an embodiment auto present or suggest one or more or group(s) or list(s) of keyword(s) or key phrase(s) based on based on date, time, user activities, actions, events, transactions, logs, interactions, senses, locations, check-in places, updates, status, current trends, connections, connected users' data, user profile, preferences, privacy settings, shared data & any combination thereof.

In an embodiment enabling users to view, store, edit, update, process, sort, filter, bookmark, rank or rate, like, dislike, report, reply, ignore, provide comments, follow source, follow followers, viewers and following users of source & share contents.

In an embodiment enabling user to receive, search, request, follow & view one or more user selected keywords or key phrases or categories or taxonomies specific contents, wherein contents comprising contents posted by users of network under one or more user(s) created one or more keywords or key phrases or categories or taxonomies.

In an embodiment enabling users to post contents under one or more user created, select users of network created one or more keywords or key phrases or categories or taxonomies.

In another embodiment enabling user(s) to send request(s), wherein request(s) comprising requesting one or more keyword(s) or key phase(s) specific real-time contents from provider(s); storing request(s); searching & matching request(s) specific contextual real-time provider(s) of contents; real-time presenting or sending request(s) to contextual provider(s) of contents; and enabling provider(s) to real-time post or share or send or update request(s) specific contents.

In an embodiment enabling request(s) receiver(s) to accept, make request as pending, ignore or decline request(s).

In an embodiment searching & matching request(s) specific contextual provider(s) based on keyword(s) or key phrase(s) specific content providers or posting users or publishers, locations, matched user profile & user data, user logs, activities, actions, interactions, behavior, senses, events, transactions, status, updates, connections, shared contents, presence information, locations, check-in places.

In an embodiment enabling request(s) to request one or more types of contents.

In an embodiment one or more types of contents comprising advertisements, news, blogs, search results, questions, answers, message, communication or conversation, collaborative contents, availability, posts, shared contents, profile, fields and associate values, domain or subject related forms specific structured contents, location, products, services, lists, comments, reviews, suggestions, thoughts, one or more types of media including text, photo, video, audio, image, link, document or file, application, object, interface, controls, widget, web service, structured contents via one or more types of forms, custom forms, wizards, interactive forms & interfaces.

In an embodiment adding points to providers of keyword(s) or key phase(s) specific real-time contents.

In an embodiment deducting points from requester(s) of keyword(s) or key phase(s) specific real-time contents.

In an embodiment auto sending one or more auto identified, suggested, selected, sensed or detected requests.

In an embodiment auto sending one or more auto identified, suggested, selected, sensed or detected requests based on date, time, user activities, actions, events, transactions, logs, interactions, senses, locations, check-in places, updates, status, current trends, connections, connected users' data, user profile, preferences, privacy settings, shared data & any combination thereof.

In an embodiment enabling the user to program sending or posting of request(s) or requesting and receiving requested one or more keyword(s) or key phase(s) specific real-time contents from provider(s).

In another embodiment auto identifying, determining, searching, matching, suggesting, selecting, detecting & presenting one or more keyword(s) and key phrase(s) related to user or enabling user select, highlight, select highlighted, select suggested, select from web page or document, input, edit, update, select via auto-fill or auto-complete one or more keyword(s) and key phrase(s); and presenting keyword(s) and key phrase(s) specific real-time user generated or posted or provided or presented or published or shared or updated contextual one or more types of contents.

In an embodiment auto identifying, determining, searching, matching, suggesting, selecting, detecting & presenting one or more keyword(s) and key phrase(s) based on user profile, user data, user logs, activities, actions, interactions, behavior, senses, events, transactions, status, updates, connections, shared contents, presence information, locations, check-in places, generally useful, popular, current topics, news & trends,

In an embodiment presenting keyword(s) and key phrase(s) specific contents comprising contents posted by users, keyword(s) and key phrase(s) specific publishers or posting or sharing users specific contents including included, excluded, broader match, narrow match, exact match, phrase match contents, search results, contents from databases or sources, past posted or shared or publishes contents, contents suggested by contacts, followers, viewers & platform or server, auto select, suggest & update preferences specific contents including categories, taxonomies, keyword(s) and key phrase(s), get auto contents or feeds from contacts or selected contacts & connections, advertisements & news to use contents, contextual contents from one or more selected contacts & connections, followers, viewers.

In an embodiment auto send said auto identified, determined, searched, matched, suggested, selected, detected & presented one or more keyword(s) and key phrase(s) specific content request(s) to provider(s); storing request(s); searching & matching request(s) specific contextual real-time provider(s) of contents; real-time presenting or sending request(s) to contextual provider(s) of contents; and enabling provider(s) to real-time post or share or send or update request(s) specific contents.

In an embodiment keyword(s) comprises one or more or group(s) of exact, matched, broader matched, alternative, similar keywords, sequence of words or characters, categories, sub-categories, taxonomies, names, named entities, nodes, items, list, locations, key phrases, ontology, semantic syntax, sentence.

In an embodiment presenting categories or taxonomy wise directories of keyword(s) key phrase(s) specific real-time user generated or posted or provided or presented or published or shared or updated contextual one or more types of contents.

In another embodiment present invention enabling user(s) to search, match, browse, select, set, apply & update one or more categories and taxonomies to follow posted contents related to or posted under said one or more categories and taxonomies by providers or posting users; enabling user(s) to post contents; store contents; determining or updating one or more categories and taxonomies of posted contents; matching followed categories and taxonomies of user(s) with said determined categories and taxonomies of said posted contents; and presenting followed one or more categories and taxonomies specific contents to categories and taxonomies followers.

In another embodiment viewing user is enabled to follow posted content associate sources.

In another embodiment viewing user is enabled to follow posted content associate one or more followers of source(s).

In another embodiment viewing user is enabled to follow posted content to associate one or more viewers.

In another embodiment user is enabling follow one or more sources of received posts.

In another embodiment user is enabling schedule posting and schedule presenting.

In another embodiment user is enabling hide or show posts, un-follow one or more categories & taxonomies and un-follow source(s) of post(s).

In another embodiment presenting posts real-time up-to set a particular period of time by sending or posting users.

In another embodiment present received contents based on date and time, preferences of order of followed categories and taxonomies, most liked, rated & commented posts and/or sources, applied sorting order including sources wise, location wise, categories or taxonomies wise, applied filter criteria.

In another embodiment enabling user to refer or share one or more posts, sources, followed categories or taxonomies to one or more contacts or connections of user for enabling them to view shared post(s) and/or follow source(s) of post(s) and/or follow one or more categories or taxonomies.

In another important embodiment enabling users to select or unselect selected or accept requested & invited one or more types of participation or contribution or content or management related activities, actions, events, collaboration, communication, interactions, transactions, tasks, workflow and associate settings including participation related to one or more keywords, key phrases, categories or taxonomies, participation date & time or scheduling, search, match, select, install, subscribe, make payment, select from suggested & register one or more associate contextual applications, services, data or contents, widgets, interactive forms & interfaces.

In another embodiment contextually presenting said selected types of participation or contribution or content or management related activities, actions, events, collaboration, communication, interactions, transactions, tasks, workflow of one or more users of network in/within/at/on one or more users' profiles, posts or shared contents, one or more keywords, key phrases, categories or taxonomies, list of followers, lists, viewers, following users, contacts, requests and one or more types of prominent places of web page, web site, applications, widgets, web services & interfaces.

In another embodiment presenting, suggesting, allowing, notifying to user said selected types of participation or contribution or content or management related activities, actions, events, collaboration, communication, interactions, transactions, tasks, workflow specific posts or shared contents or requests or invitations or allowance or questions from other users of network including followers, viewers, following users, contacts to enable to provide or conduct or participate in one or more types of participation or contribution or content or management related activities, actions, events, collaboration, communication, interactions, transactions, tasks, workflow.

In another embodiment enabling users to provide or fulfill or take or execute or conduct said selected one or more types of participation or contribution or content or management related activities, actions, events, collaboration, communication, interactions, transactions, tasks, and workflow.

In another embodiment enabling users to ask, suggest, allow, alert, notify, remember, request, invite for & rate, rank, like, dislike, comment said one or more participated users and/or one or more types of participation or contribution or content or management related activities, actions, events, collaboration, communication, interactions, transactions, tasks, workflow of users.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of one embodiment of an environment in which the invention may be practiced;

FIG. 2 illustrates exemplary graphical user interface (GUI) for enabling users to post one or more selected, searched, matched, suggested, auto matched or auto associated keyword(s) or key phrase(s) specific one or more types of contents, so keyword(s) or key phrase(s) related followers or viewers can receive, view & access contextual posts or shared contents;

FIG. 3 illustrates exemplary graphical user interface (GUI) for enabling users to view received posts including followed, preference based and requested keyword(s) or key phrase(s) specific posts or shared contents and enabling user to take one or more actions;

FIG. 4 illustrates exemplary graphical user interface (GUI) for enabling users to use one or more options for following one or more keywords, key phrases, categories & taxonomies specific posted contents;

FIG. 5 illustrates exemplary graphical user interface (GUI) for enabling users to use one or more options for following one or more sources, users, people, contacts, named entities;

FIG. 6 illustrates exemplary graphical user interface (GUI) for enabling users to provide and receive request(s) specific real-time contents from contextual users;

FIG. 7 illustrates exemplary graphical user interface (GUI) for enabling users to automatically provide and receive real-time posted contents from contextual users;

FIG. 8 illustrates exemplary graphical user interface (GUI) for enabling users to follow one or more categories and/or taxonomies preferences specific posted contents;

FIG. 9 illustrates exemplary graphical user interface (GUI) for enabling users to post contents, so categories and/or taxonomies specific followers can real-time receive said posted contextual contents;

FIG. 10 illustrates exemplary graphical user interface (GUI) for enabling users to view followed categories and/or taxonomies specific real-time posted contextual contents;

FIG. 11 illustrates exemplary graphical user interface (GUI) for enabling users to view, manage posted contents by user under various keywords, key phrases, categories and taxonomies and enabling to take one or more users actions on one or more posts including view, edit, update, re-share or share posts, view statistics, details of viewers, follow viewers, follow following and/or followers of viewing users;

FIG. 12 illustrates exemplary graphical user interface (GUI) for enabling users to view, access and manage viewers of user's posted contents and take one or more actions including view or access viewer's public profile, view statistics of viewers, list of keyword(s) or key phrase(s) specific viewers, follow viewer(s), invite viewers to follow user, participate in updating of posts, sort & filter viewers and like;

FIG. 13 illustrates exemplary graphical user interface (GUI) for enabling users to view, access and manage user's following user as well as one or more followed keywords, key phrases, categories, taxonomies of one or more sources and enabling user to take one or more actions on one or more selected following users including un-follow, follow following users, followers, lists & viewers of one or more sources, people, keywords, key phrases, categories & taxonomies of following users, invite to add to contacts, rank, order, filter, groups, categories, lists, report, hide, show, share, refer and view, sort, rank, filter, report, hide, show & categories one or more following users contents, pause or re-start receiving of posts from following users or sources;

FIG. 14 illustrates exemplary graphical user interface (GUI) for enabling users to view, access and manage followers of user as well as followers of user's one or more keywords, key phrases, categories, taxonomies under which user posts or share contents and enabling user to take one or more actions including select one or more followers, invite to add to contacts, rank, order, filter, groups, categories, lists, share, refer, follow or un-follow followers, lists & viewers of one or more followers and one or more keywords, key phrases, categories & taxonomies of one or more followers, view statistics, view number of views, ranks, comments, likes or dislikes, further addition or updating of contents associate with posted contents by follower(s);

FIG. 15 illustrates exemplary graphical user interface (GUI) for enabling users to view, access and manage contacts or connections of user including search, match, sort, filter, group, categories, lists, refer, share, rank, order, hide, show, follow, un-follow, invite to follow user;

FIG. 16-20 illustrates exemplary graphical user interface (GUI) for enabling users to create, manage, view, access, edit or update, search, match, select, follow, follow one or more members, apply privacy settings, preferences, refer, share one or more lists of sources, people, keywords, key phrases, categories & taxonomies;

FIG. 21 illustrates exemplary graphical user interface (GUI) for enabling users of network to follow user's one or more or list(s) of keywords, key phrases, categories & taxonomies, view related followers, viewers, contacts, related posts or shared contents, enabling user to take one or more user actions including view keywords, key phrases, categories & taxonomies specific posts, view statistics including number of followers & viewers, ratings, comments, likes or dislikes, follow followers and viewers related followers and viewing users, search, match, browse, sort, filter, rank, order, group, list, categories, refer, share one or more keywords, key phrases, categories & taxonomies;

FIG. 22 illustrates exemplary graphical user interface (GUI) for enabling user to select, input, apply, set and update one or more types of presentation, publishing or posting or sharing and participation settings;

FIG. 23 illustrates exemplary graphical user interface (GUI) for enabling users to search, match, browse & select various micro-channels to receive all or one or more selected types of live media or contents. User can also select keywords with micro channels so user can prioritize in receiving selected keyword specific contents then other contents in same selected micro channels;

FIG. 24 illustrates exemplary graphical user interface (GUI) for enabling user to broadcast or live post one or more selected types of contents for contextual viewers;

FIG. 25 illustrates exemplary graphical user interface (GUI) for enabling user to access list of selected micro channel(s) specific live contents;

FIG. 26 illustrates exemplary graphical user interface (GUI) for enabling user to view, play, pause, remove from user's list, reply, skip, save, like, dislike, comment one or more type of live content(s) or media including live stream, video, photo, audio, text and any combination thereof;

FIG. 27 illustrates exemplary graphical user interface (GUI) for enabling user to browse live micro channel and view selected micro channel specific live one or more types of media or contents;

FIG. 28 illustrates exemplary graphical user interface (GUI) for enabling user to view various types of statistics and apply various settings;

FIG. 29 illustrates an example computer system suitable for implementing various components of the system and method for real time viewing contextual shared contents or posts based on one or more methods & system and providing & following keyword(s) specific contents based system, according to some embodiments;

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. The headings used herein are for organizational purposes only and are not meant to be used to limit the scope of the description. As used throughout this application, the word “may” is used in a permissive sense (e.g., meaning having the potential to), rather than the mandatory sense (e.g., meaning must). Similarly, the words “include”, “including”, and “includes” mean including, but not limited to.

### DETAILED DESCRIPTION OF THE DRAWINGS

Various embodiments of a system and method for request based real-time or near real-time or live broadcasting, sharing and providing user services are described. In the following description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

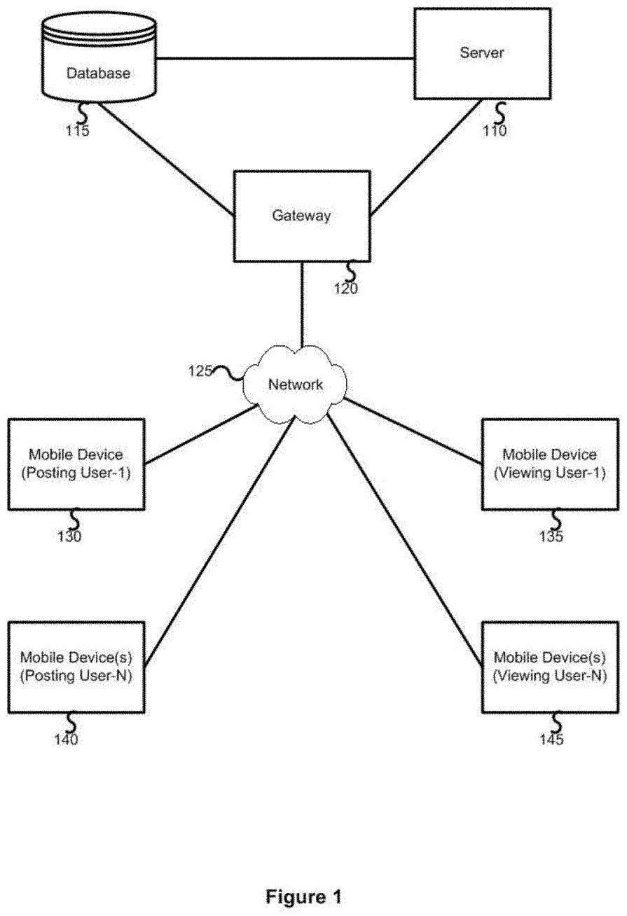

The system for enabling users to provide, publish, present, post, update, broadcast, send, synchronize, advertise one or more or group(s) of keywords including exact, verified, similar, broader or matched phrases, key phrases, categories, taxonomies, ontology specific one or more types of contents & enable to follow, subscribe, view, search, match, select, browse keyword(s) specific contents may be referred to herein, for simplicity, as the “providing & following keyword(s) specific contents based system.” FIG. 1 illustrates a block diagram of an enabling posting user to post user provided contents to keyword(s) specific contextual followers or viewers. Providing & following keyword(s) specific contents based system configured to implement the platform where user(s) can search, match, browse, select, set, apply & update one or more or group(s) or set of similar or related or matched keywords, key phrases, named entities, nodes, ontology, categories and taxonomies to follow posted contents related to or posted under said one or more or group(s) or set of similar or related or matched keywords, key phrases, named entities, nodes, ontology, categories and taxonomies by providers or posting users and post contents with the intent to receive posted contents by contextual viewers based on followed or group(s) or set of similar or related or matched keywords, key phrases, named entities, nodes, ontology, categories and taxonomies and user data including user profile, activities, actions, events, transactions, logs, interactions, senses, locations, check-in places, updates, status, current trends, connections, connected users' data, preferences, privacy settings, shared data & any combination thereof. While FIG. 1 illustrates a gateway 120, a database 115 and a server 110 as separate entities, the illustration is provided for example purposes only and is not meant to limit the configuration of the providing & following keyword(s) specific contents based system. In some embodiments, gateway 120, database 115 and server 110 may be implemented in the providing & following keyword(s) specific contents based system as separate systems, a single system, or any combination of systems.

As illustrated in FIG. 1, the providing & following keyword(s) specific contents based system may include a posting user device or mobile devices 130/140 and viewing user device or mobile devices 135/145. Devices or Mobile devices 130/140/135/145 may be particular set number of or an arbitrary number of devices or mobile devices which may be capable of posting, sharing, publishing, broadcasting, advertising, sending, presenting, accessing and managing shared contents to target followers, contextual viewers or users of network who follow particular or one or more or group(s) or set of similar or related or broader matched or matched keywords, key phrases, named entities, nodes, ontology, categories and taxonomies. Each device or mobile device in the set of posting user(s) 130/140 and viewing user(s) device or mobile devices 135/140 may be configured to communicate, via a wireless connection, with each one of the other mobile devices 130/140/135/145. Each one of the mobile devices 130/140/135/145 may also be configured to communicate, via a wireless connection, to a network 125, as illustrated in FIG. 1. The wireless connections of mobile devices 130/140/135/145 may be implemented within a wireless network such as a Bluetooth network or a wireless LAN.

As illustrated in FIG. 1, the providing & following keyword(s) specific contents based system may include gateway 120. Gateway 120 may be a web gateway which may be configured to communicate with other entities of the providing & following keyword(s) specific contents based system via wired and/or wireless network connections. As illustrated in FIG. 1, gateway 120 may communicate with mobile devices 130/140/135/145 via network 125. In various embodiments, gateway 120 may be connected to network 125 via a wired and/or wireless network connection. As illustrated in FIG. 1, gateway 120 may be connected to database 115 and server 110 of providing & following keyword(s) specific contents based systems. In various embodiments, gateway 120 may be connected to database 115 and/or server 110 via a wired or a wireless network connection.

Gateway 120 may be configured to send and receive posts or data (e.g. real time posting of keyword(s) or key phrase(s) specific user provided or user generated contents to prospective, matched & contextual followers or viewers based on keyword(s) preferences and matched user data of users, wherein user data comprises user profile, user connections, connected users' data, user shared data or contents, user logs, activities, actions, events, senses, transactions, status, updates, presence information, locations, check-in places and like) to/from mobile devices 130/140/135/145. For example, gateway 120 may be configured to receive posted contents provided by posting users or publishers or content providers to database 115 for storage.

As another example, gateway 120 may be configured to send or present posted contents to followers of keyword(s), key phrase(s), categories & taxonomies or contextual viewers stored in database 115 to mobile devices 130/140/135/145. Gateway 120 may be configured to receive search requests from mobile devices 130/140/135/145 for searching and presenting posted contents.

For example, gateway 120 may receive a request from a mobile device and may query database 115 with the request for searching and matching request specific matched posted contents, sources, followers, following users and viewers. Gateway 120 may be configured to inform server 110 of updated data. For example, gateway 120 may be configured to notify server 110 when a new post has been received from a mobile device or device of posting or publishing or content broadcaster(s) or provider(s) stored on database 115.

As illustrated in FIG. 1, the providing & following keyword(s) specific contents based system may include a database, such as database 115. Database 115 may be connected to gateway 120 and server 110 via wired and/or wireless connections. Database 115 may be configured to store a database of registered user's profile, accounts, posted or shared contents, followed updated keyword(s), key phrase(s), named entities, nodes, ontology, semantic syntax, categories & taxonomies, user data, payments information received from mobile devices 130/140/135/145 via network 125 and gateway 120.

Database 115 may also be configured to receive and service requests from gateway 120. For example, database 115 may receive, via gateway 120, a request from a mobile device and may service the request by providing, to gateway 120, user profile, user data, posted or shared contents, user followers, following users, viewers, contacts or connections, user or provider account's related data which meet the criteria specified in the request. Database 115 may be configured to communicate with server 110.

As illustrated in FIG. 1, the providing & following keyword(s) specific contents based system may include a server, such as server 110. Server may be connected to database 115 and gateway 120 via wired and/or wireless connections. As described above, server 110 may be notified, by gateway 120, of new or updated user profile, user data, user posted or shared contents, user followed updated keyword(s), key phrase (s), named entities, nodes, ontology, semantic syntax, categories & taxonomies & various types of status stored in database 115.

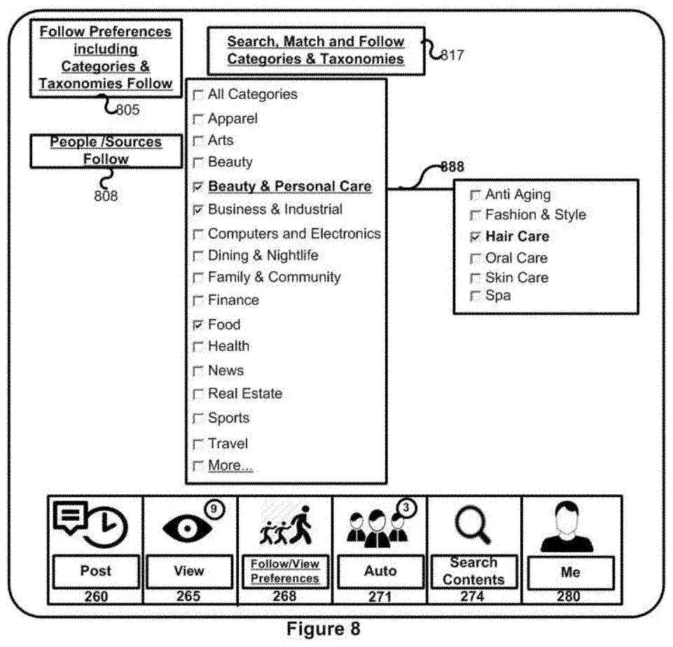

In another embodiment the system for presenting & broadcasting users generated contents to contextual viewers based on user preferences & user data (discussed in detail in FIGS. 8-10) may be referred to herein, for simplicity, as the “broadcasting user contents to contextual viewers based system.” FIG. 1 illustrates a block diagram of an broadcasting user contents to contextual viewers based system configured to implement the platform where user(s) can search, match, browse, select, set, apply & update one or more categories and taxonomies to follow posted contents related to or posted under said one or more categories and taxonomies by providers or posting users and post contents with the intent to receive posted contents by contextual viewers based on followed categories & taxonomies and user data. While FIG. 1 illustrates a gateway 120, a database 115 and a server 110 as separate entities, the illustration is provided for example purposes only and is not meant to limit the configuration of the broadcasting user contents to contextual viewers based system. In some embodiments, gateway 120, database 115 and server 110 may be implemented in the broadcasting user contents to contextual viewers based systems as separate systems, a single system, or any combination of systems.

As illustrated in FIG. 1, the broadcasting of user contents to contextual viewers based system may include a posting user device or mobile devices 130/140 and viewing user device or mobile devices 135/145. Devices or Mobile devices 130/140/135/145 may be particular set number of or an arbitrary number of devices or mobile devices which may be capable of posting, sharing, publishing, broadcasting, advertising, sending, presenting, accessing and managing shared contents to target contextual viewers or users of network who follow particular categories & taxonomies. Each device or mobile device in the set of posting user(s) 130/140 and viewing user(s) device or mobile devices 135/140 may be configured to communicate, via a wireless connection, with each one of the other mobile devices 130/140/135/145. Each one of the mobile devices 130/140/135/145 may also be configured to communicate, via a wireless connection, to a network 125, as illustrated in FIG. 1. The wireless connections of mobile devices 130/140/135/145 may be implemented within a wireless network such as a Bluetooth network or a wireless LAN.

As illustrated in FIG. 1, the broadcasting user contents to contextual viewers based systems may include gateway 120. Gateway 120 may be a web gateway which may be configured to communicate with other entities of the broadcasting user contents to contextual viewers based systems via wired and/or wireless network connections. As illustrated in FIG. 1, gateway 120 may communicate with mobile devices 130/140/135/145 via network 125. In various embodiments, gateway 120 may be connected to network 125 via a wired and/or wireless network connection. As illustrated in FIG. 1, gateway 120 may be connected to database 115 and server 110 of the broadcasting user contents to contextual viewers based systems. In various embodiments, gateway 120 may be connected to database 115 and/or server 110 via a wired or a wireless network connection.

Gateway 120 may be configured to send and receive posts or data (e.g. real time broadcasting categorized user generated contents to prospective, matched & contextual viewers based on preferences and matched user data of users, wherein user data comprises user profile, user connections, connected users' data, user shared data or contents, user logs, activities, actions, events, senses, transactions, status, updates, presence information, locations, check-in places and like) to/from mobile devices 130/140/135/145. For example, gateway 120 may be configured to receive posted contents provided by posting users or publishers or content broadcasters to database 115 for storage.

As another example, gateway 120 may be configured to send or present posted contents to followers of categories & taxonomies or contextual viewers stored in database 115 to mobile devices 130/140/135/145. Gateway 120 may be configured to receive search requests from mobile devices 130/140/135/145 for searching and presenting posted contents.

For example, gateway 120 may receive a request from a mobile device and may query database 115 with the request for searching and matching request specific matched posted contents, sources, followers, following users and viewers who are located at request specific place(s) or location(s). Gateway 120 may be configured to inform server 110 of updated data. For example, gateway 120 may be configured to notify server 110 when a new post has been received from a mobile device or device of posting or publishing or content broadcaster(s) provider(s) stored on database 115.

As illustrated in FIG. 1, the broadcasting user contents to contextual viewers based systems may include a database, such as database 115. Database 115 may be connected to gateway 120 and server 110 via wired and/or wireless connections. Database 115 may be configured to store a database of registered user's profile, accounts, posted or shared contents, followed updated categories & taxonomies, user data, payments information received from mobile devices 130/140/135/145 via network 125 and gateway 120.

Database 115 may also be configured to receive and service requests from gateway 120. For example, database 115 may receive, via gateway 120, a request from a mobile device and may service the request by providing, to gateway 120, user profile, user data, posted or shared contents, user or provider account's related data which meet the criteria specified in the request. Database 115 may be configured to communicate with server 110.

As illustrated in FIG. 1, the broadcasting user contents to contextual viewers based systems may include a server, such as server 110. Server may be connected to database 115 and gateway 120 via wired and/or wireless connections. As described above, server 110 may be notified, by gateway 120, of new or updated user profile, user data, user posted or shared contents, user followed updated categories & taxonomies & various types of status stored in database 115.

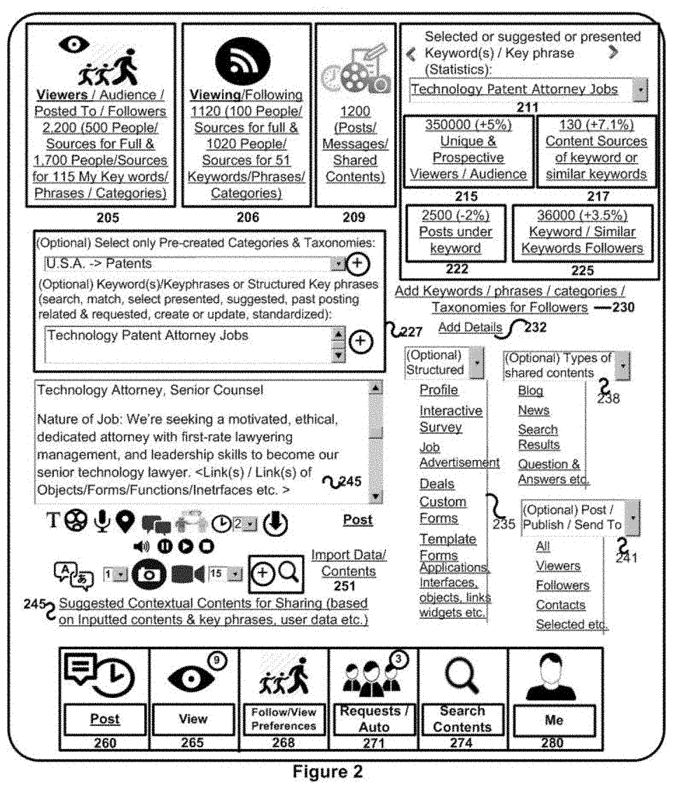

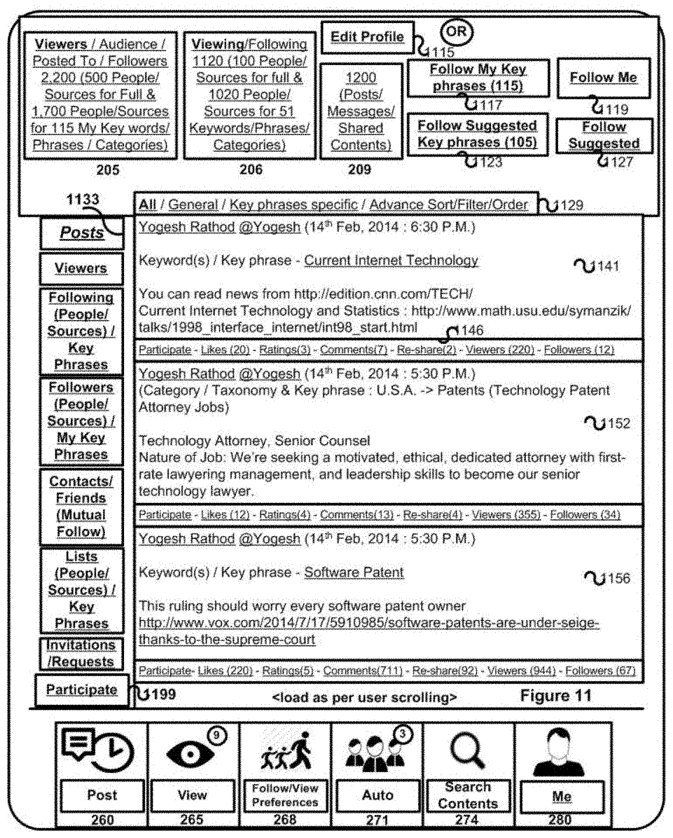

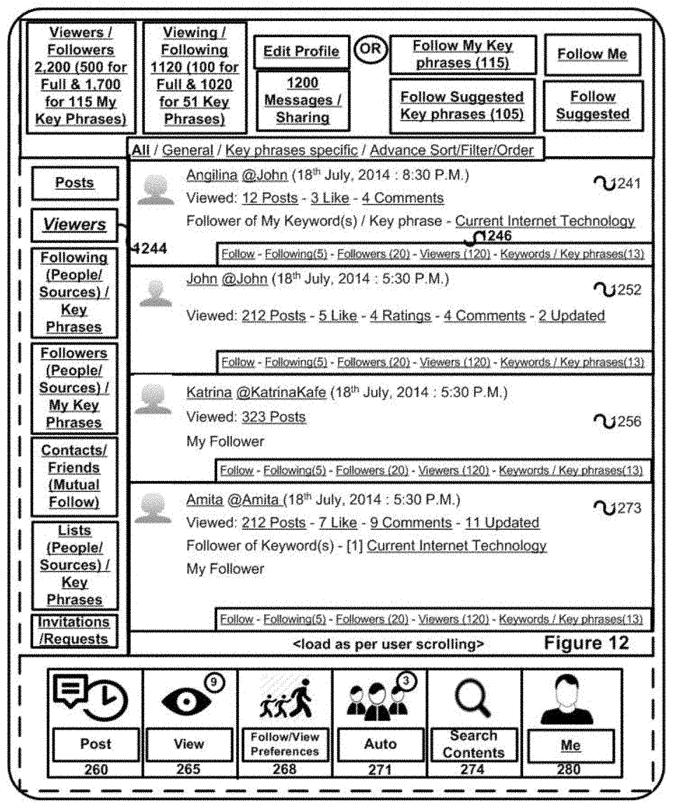

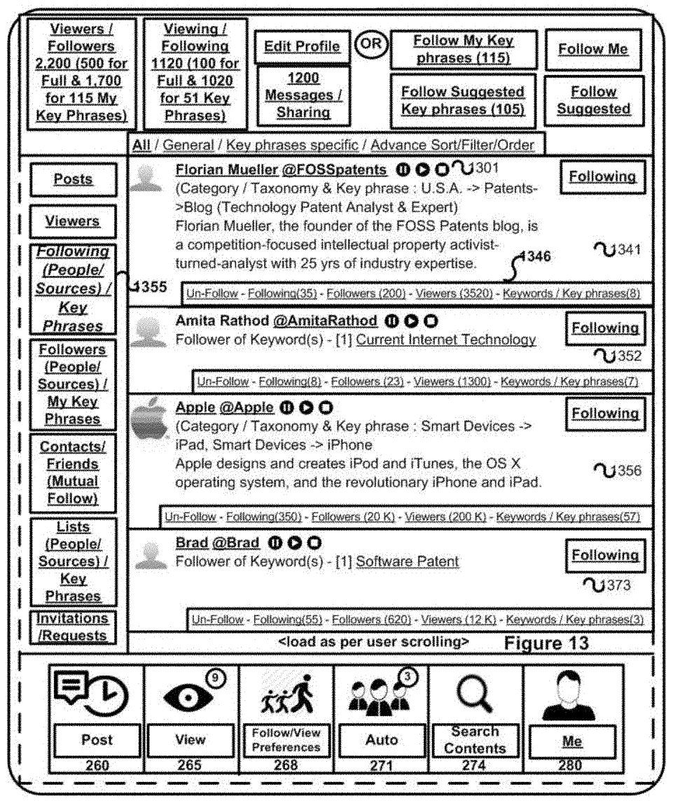

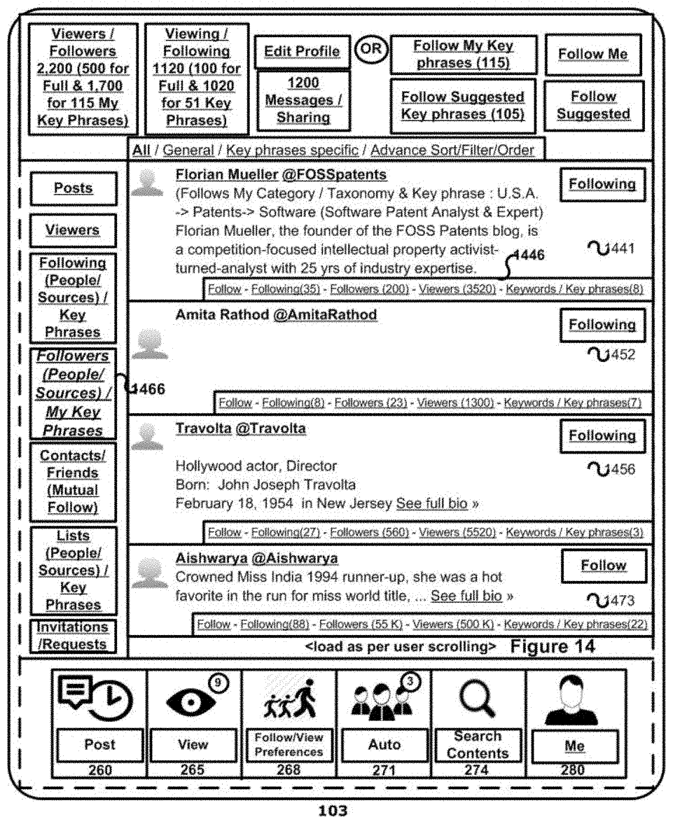

FIG. 2 illustrates Graphical User Interface (GUI) for enabling user to post or share or publish one or more types of contents 245 including post or share or publish structured or un-structured contents under/in/for selected one or more keywords, key phrases, categories & taxonomies including search, matched, selected, selected from suggested, user created or updated & verified, select from network-wide standardized, select request(s) or associate keyword(s), select from past used or selected keywords, key phrases, categories & taxonomies 227 for posting or sharing or publishing one or more types of contents, so users or contextual viewers can receive & view based on user provided preferences, requests & user data, followed users or sources or keywords, key phrases, categories & taxonomies specific, search & access said one or more posted or shared or published one or more types of contents under/in/for selected one or more keywords, key phrases, categories & taxonomies. User can view user's numbers of followers and user's numbers of keywords, key phrases, categories & taxonomies specific followers i.e. users of network who followed user's one or more keywords, key phrases, categories & taxonomies and viewers 205 and access or view list of viewers & followers (discuss in detail in FIGS. 12 and 14). User can view user's numbers of following users and following keywords, key phrases, categories & taxonomies of users 206 and access or view list of following users and list of users whose keywords, key phrases, categories & taxonomies (discuss in detail in FIG. 13) or posts user is viewing based on preferences (discuss in detail in FIG. 8). Users can view and access numbers of and all posted one or more types of contents 209 (discuss in detail in FIG. 11). User can view one or more selected keywords, key phrases, categories & taxonomies specific statics 211 including selected or similar keyword, key phrase, category or taxonomy specific number of unique & prospective viewers or audience 215, number of sources or users who are posting under or in or for said selected or similar keyword, key phrase, category or taxonomy 217, number of posts under or in or for said selected or similar keyword, key phrase, category or taxonomy 222, number of followers of said selected or similar keyword, key phrase, category or taxonomy 225 and can access said lists and take one or more actions including view, bookmark, rate contents, follow said selected or similar keyword, key phrase, category or taxonomy, follow followers, viewing users and following users of sources of said selected or similar keyword, key phrase, category or taxonomy. Users are enabled to add new or update and verify or validate one or more keywords, key phrases, categories or taxonomies to global directories for enabling followers to follow standardized and unique keywords, key phrases, categories or taxonomies. Users can also enable to provide details about said keywords, key phrases, categories or taxonomies including description, similar keywords, key phrases, categories or taxonomies, metadata, image or photo or video or links or voice or documents. In one embodiment user is also presented with selected one or more keywords, key phrases, categories or taxonomies 227 specific suggested or contextual one or more types of contents 245, so user can view, read, analyze, said selected or preferred contents and can post or share or provide user drafted or updated or user generated contents. Users can also search, match, select, update, select from templates and input, select, update contents or data and post or share or send or publish one or more types of structured contents including one or more types of subject or domain specific profiles, survey forms, Job forms, advertisements, deals, customize forms, template forms, contents post via applications or interfaces or widgets, so followers or receiving or viewing users can data mine, text analyze share contents including compare, search, filter, rank, various types of views, calculate, export to structured database or applications 235. In another embodiment users can also select one or more categories or types of contents including blog, news, message, search result, question, answer, notes, alerts & notifications. In another embodiment user can post contents to one or more contacts or connections, groups, make as public or private or save locally or any storage medium, friends of friends, followers, following users, viewers, followers & following users of contacts, followers, following users, & viewers, sources, databases, web sites, applications, social networks, search engines.

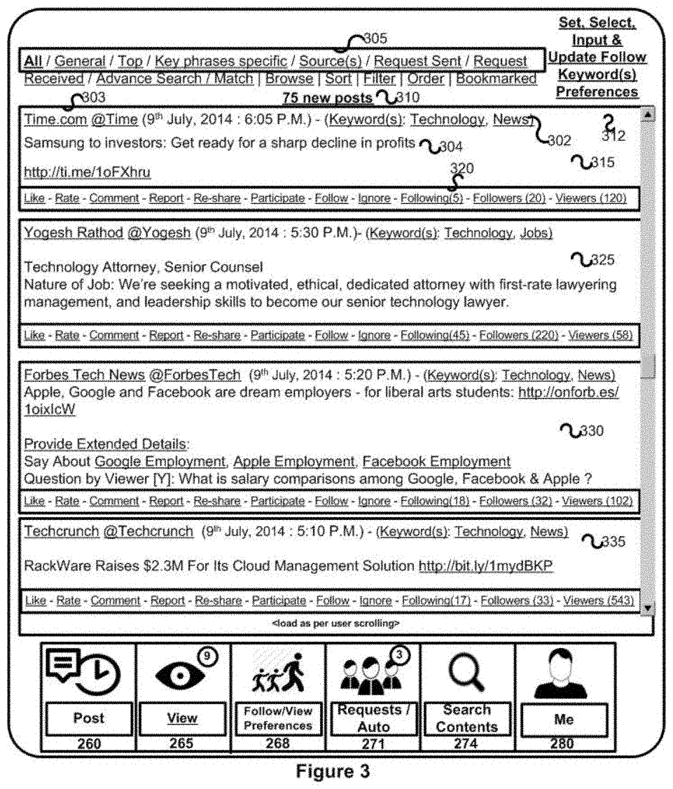

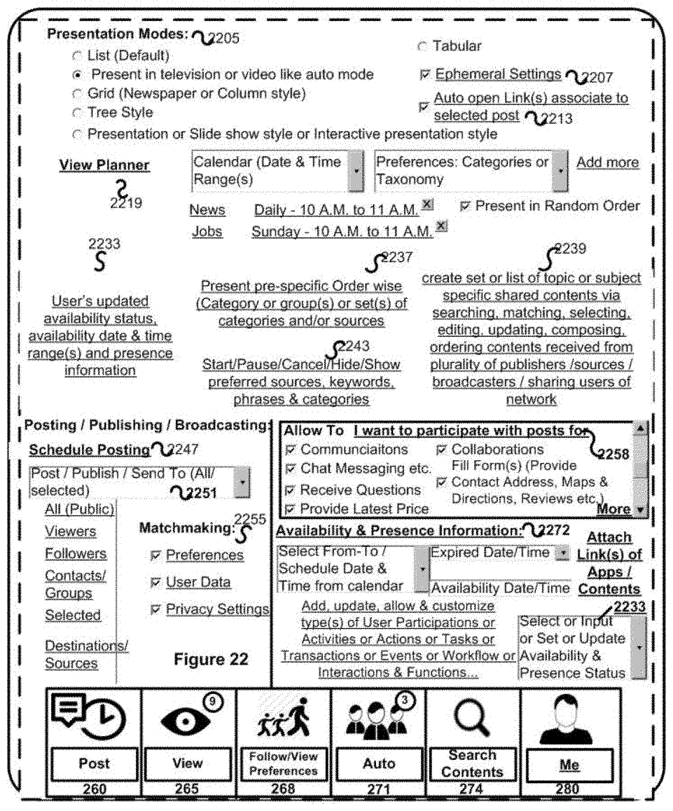

FIG. 3 illustrates Graphical User Interface (GUI) for enabling user to receive, update & view posted contents from following users 303, following keywords, key phrases, categories or taxonomies of users or sources 302, user contacts or connections 303 and enabling to take one or more user actions including like, rate, re-share, favorite, ignore, comment on one or more posts and report source, follow one or more post associate source(s) or follow one or more post associate one or more keywords, key phrases, categories or taxonomies, view, follow & access list of viewing, followings and follower users, update post(s), reply post(s), bookmark, rank, order, sort, filter, rate, import, export, list, group posts or sources of posts or associate keywords 320. In another embodiment user is enable to search, match, select, set, input, select, update one or more followed or intent to following one or more keywords, key phrases, categories or taxonomies or sources or people or users or selected preferences specific (discuss in detail in FIG. 8), so user can receive updated followed or preference specific posts 312. Viewing user can select or apply one or more presentation settings and modes (discussed in detail in FIG. 22). User can apply or select one or more types of filters including view all, current, general, top, source wise, keyword wise, source(s) or keyword wise in tabular format or switching mode, request sent or request received specific, followed sources or people or one or more keywords, key phrases, categories or taxonomies, use advance search for inputting, selecting, updating and setting or applying one or more criteria, browsing directories or taxonomy wise, order or sort by date & time, source profile related one or more attributes including gender, age range, qualification, location, occupation, school, college and like, ascending or descending chronological orders, show bookmarked, most rated, most viewed, most commented, most liked 305. Users can dynamically hide, show, attach or detach, remove, group, add to categories or group, order, add one or more posts in presented posts.

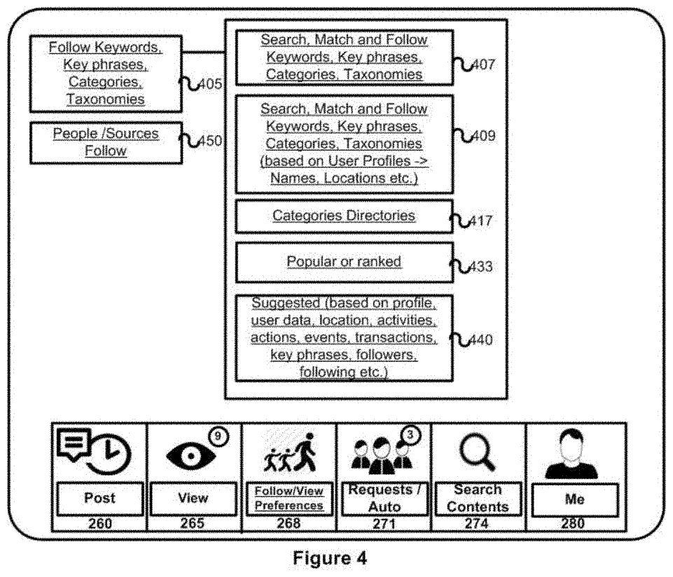

FIG. 4 illustrates Graphical User Interface (GUI) for enabling or facilitating user to choose one or more options to search, match & follow or receive to view one or more keywords, key phrases, categories or taxonomies specific posted or shared one or more types of contents 405 including search, match, select and follow or receive to view one or more or set or group(s) or list(s) of keywords, key phrases, categories or taxonomies specific posted or shared one or more types of contents 407, search, match, select & follow or receive to view posts based on searching or selecting one or more fields of user profiles including name, surname, location, check-in places, qualification, age range, school, collage, occupation, type of business, interest, type of user activities, actions, events, transactions & like 409, search, match, browse, select and follow from one or more directories or lists of keywords, key phrases, categories or taxonomies 417, search, match, browse, select and follow from most popular, trended, most liked or rated or commented or favorite or bookmarked or viewed or followed keywords, key phrases, categories or taxonomies 443, search, match, browse, select and follow or receive to view from suggested lists of keywords, key phrases, categories or taxonomies based on user data, user profile, user connections, followers, viewers, following users, locations, checked-in places, activities, actions, events, transactions, status, updates, shared contents, behavior, senses 440.

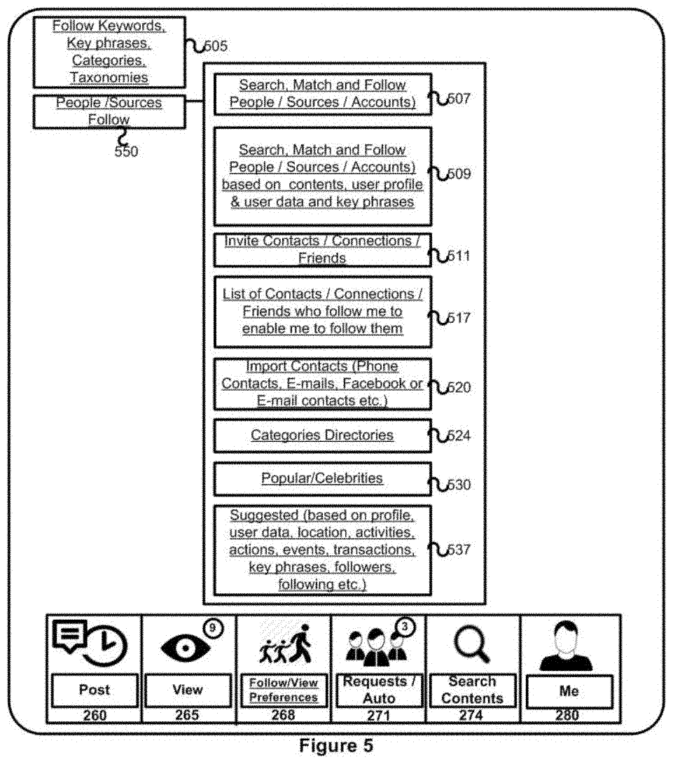

FIG. 5 illustrates Graphical User Interface (GUI) for enabling or facilitating user to choose one or more options to search, match & follow one or more sources or users or people or entities or named entities or nodes of network or their one or more keywords, key phrases, categories or taxonomies specific posted or shared one or more types of contents 550 including search, match, select and follow or receive to view one or more or set or group(s) or list(s) of sources or users or accounts or people or entities or named entities or nodes of network specific or their one or more keywords, key phrases, categories or taxonomies specific posted or shared one or more types of contents 507, search, match, select & follow sources or users or people or entities or named entities or nodes of network based on searching or selecting one or more fields of user profiles including name, surname, location, check-in places, qualification, age range, school, collage, occupation, type of business, interest, type of user activities, actions, events, transactions & like 509, user can search, invite users of network based on one or more criteria and accept requests of other known users for following with them or their one or more keywords, key phrases, categories or taxonomies and adding them to user contacts or connections 511, user is also enable to view who are in user's contacts and following to user or user's keywords, key phrases, categories or taxonomies for enabling user to follow them or their keywords, key phrases, categories or taxonomies 517, user is also enable to import contacts from one or more sources, web sites, email service providers, social networks, applications, databases and enabling to invite them for following user or user's one or more keywords, key phrases, categories or taxonomies 520, search, match, browse, select and follow from one or more directories or lists of sources or users or accounts or people or entities or named entities or nodes of network or their one or more keywords, key phrases, categories or taxonomies 524, search, match, browse, select and follow from most popular, trended, most liked or rated or commented or favorite or bookmarked or viewed or followed sources or users or celebrities or people or entities or named entities or nodes of network or their one or more keywords, key phrases, categories or taxonomies 530, search, match, browse, select and follow from suggested lists of sources or users or people or entities or named entities or nodes of network or their one or more keywords, key phrases, categories or taxonomies based on user data, user profile, user connections, followers, viewers, following users, locations, checked-in places, activities, actions, events, transactions, status, updates, shared contents, behavior, senses 537.

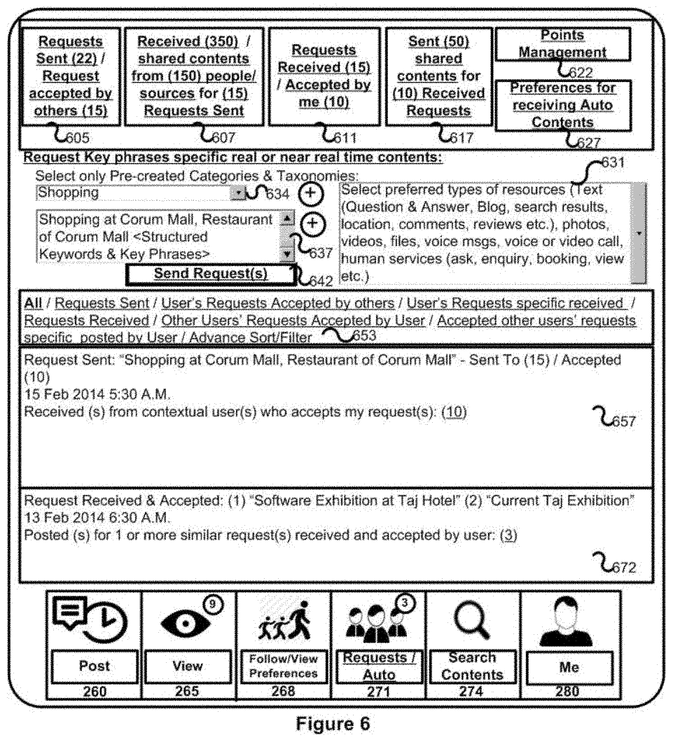

FIG. 6 illustrates Graphical User Interface (GUI) for enabling or facilitating user to send request 642 and/or one or more request types 631 including answer of question, search results, lists, directions, maps, address, availability, quality, comments, reviews, suggestions, ask one or more types of human services including ask or enquire on behalf of user or requestor, one or more types of contents including text, images, photos, audio, voice, video & documents 631 to contextual users of networks who provide request specific shared contents to user or requestor(s), wherein request comprises one or more keywords & key phrases 637, categories or taxonomies 634. Users can view, view statistics and access requests sent and requests accepted by others 605, received request(s) specific posts or shared contents from people or users or sources 607, requests received by user and requests accepted by user 611, sent request(s) specific posts or shared contents 617. User is enable to view, access, manage, bookmark, sort, filter, order, rank, rate one or more send or received requests and requests specific shared contents including all, requests sent, user's requests accepted by others, user's requests specific received shared contents, requests received by user, other users' requests accepted by user, accepted other users' requests specific posted contents or shared contents by user 653.

In another embodiment Points Management 622 enables the user to view the total number of points. When user sends requests and received request(s) specific contextual posts or shared contents from request(s) accepted users of network then system deduct points from user's total balance points and when user receives and accepts request(s) and send or share or post or publish one or more types of shared contents and contents likes or rated by receiving users then system add particular number of points to user's total balance points. Users can use or spend points for sending request(s), receive a number of responses, receive numbers of responses from numbers of people or sources or users of the network, receive responses from numbers of people or sources or users of the network. User can earned or increase points based on how quickly provide response(s), duration spent for providing one or more or one or more types of responses (shared contents), number of responses, types of responses, quality of responses based on number of received like or rank & comments, types of services and duration and like

In another embodiment user can provide preferences 627 for automatically sending requests based on user's preferences, privacy settings, user profile, user data, user shared contents, contacts, connections, followers, viewers, friends of friends, activities, actions, events, transactions, locations, checked-in places, status, presence information, updates, senses, behavior, connected users' data and automatically receiving automatically posed requests specific one or more types of contextual contents from contextual or matched users of network.

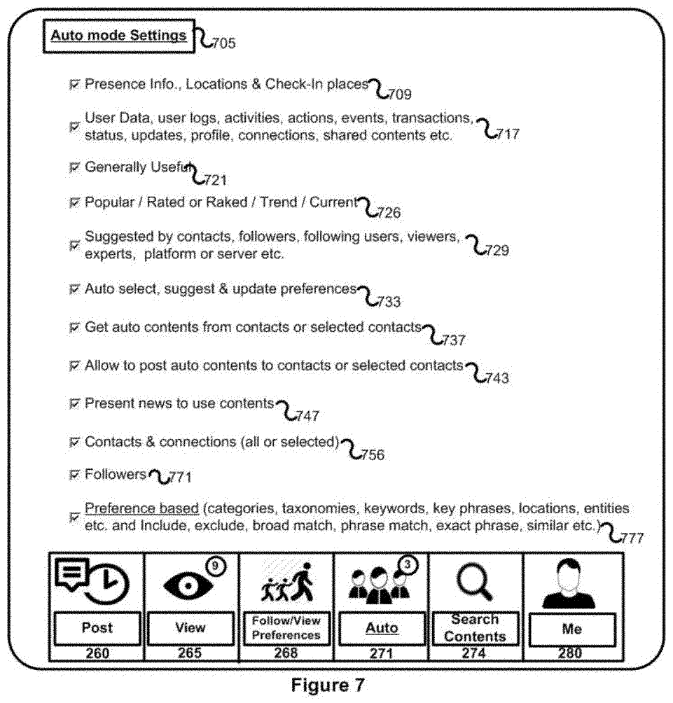

In another embodiment FIG. 7 illustrates Graphical User Interface (GUI) for enabling or facilitating user to provide preferences for automatically receive or send & view posts or one or more types of shared contents from users of network based on presence information, locations & check-in places 709, user data, user logs, activities, actions, events, transactions, status, updates, profile, connections, shared contents etc. 717, generally useful 721, popular, ranked, trended & current 726, suggested by contacts, followers, viewers, following uses, experts, sponsors or advertisers, platform or server and like 729, auto selected, suggested & update preferences 733, get auto contents from contacts or selected contacts 737, allow to post auto contents to contacts or selected contacts 743, present news to use or advertised contents 747, all or selected contacts & connections 756, followers 771, preference based including one or more selected, inputted, suggested or updated one or more included, excluded, broad matched, phrase matched, exact phrase & similar categories, taxonomies, keywords, key phrases, locations, entities 777.

In another embodiment FIG. 8 illustrates Graphical User Interface (GUI) for enabling or facilitating user to search, match, browse, select one or more globally pre-created or updated categories or taxonomies or keywords, key phrases or lists 888 for receiving said selected one or more categories or taxonomies or keywords, key phrases or lists specific or one or more similar, broader matched, narrow matched, exact matched & phrase matched categories or taxonomies or keywords, key phrases or lists specific one or more types of contextual posts or shared contents or media from contextual or matched users of network. So the system can present & broadcast users generated contents to contextual viewers based on preferences & user data and enable user(s) to real time broadcast similar contents and similar types of contents to best targeted & contextual users or viewers or readers.

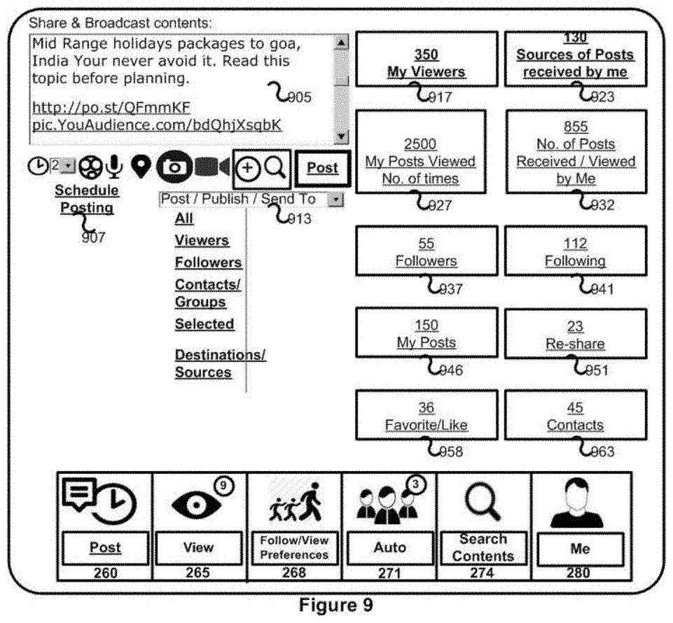

In another embodiment FIG. 9 illustrates Graphical User Interface (GUI) for enabling or facilitating users to post or share or publish or broadcast or send one or more types of contents 905 without providing or selecting associate keywords, key phrases, categories or taxonomies. System can match posted or shared or published one or more types of contents with users' preferences as discussed in detail in FIG. 8 and presented to contextual viewers. In another embodiment users can schedule or scheduling posting or publishing or broadcasting of shared contents. In another embodiment user can view, access & manage list of posted or shared or published or broadcasted contents and associate viewers of user's posts or shared or published or broadcasted contents 917, list of posts or shared contents and associate sources of posts received by user 923, view various statistics including user's posts or shared contents viewed number of times 927, number of posts received or viewed by user 932, view, access & manage list of followers 937, following users 941, posts or shared contents posted or shared or published or broadcasted by user 946, re-shared contents 951, favorite or liked or bookmarked or rated contents 958, contacts or connections of user 963.

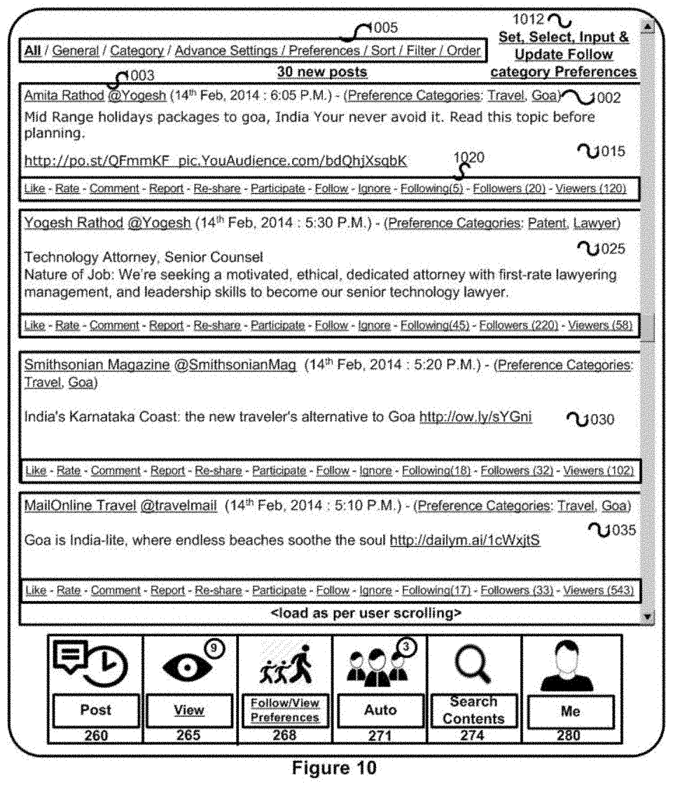

FIG. 10 illustrates Graphical User Interface (GUI) for enabling user to receive, update & view posted contents from contextual users 1003, following preference specific categories or taxonomies or keywords & key phrases of users or sources 1002, user contacts or connections 1003 and enabling to take one or more user actions including like, rate, re-share, favorite, ignore, comment on one or more posts and report source, follow one or more post associate source(s) or follow one or more post associate one or more keywords, key phrases, categories or taxonomies, view, follow & access list of viewing, followings and follower users, update post(s), reply post(s), bookmark, rank, order, sort, filter, rate, import, export, list, group posts or sources of posts or associate keywords 1020. In another embodiment user is enable to search, match, select, set, input, select, update one or more followed or intent to following one or more keywords, key phrases, categories or taxonomies or sources or people or users or selected preferences specific (discuss in detail in FIG. 8), so user can receive updated followed or preference specific posts 1012. Viewing users can select or apply one or more presentation settings and modes (discussed in detail in FIG. 22). User can apply or select one or more types of filters including view all, current, general, top, source wise, category wise, taxonomy wise, keyword wise, key phrases wise, source(s) or keyword wise in tabular format or switching mode, request sent or request received specific, followed sources or people or one or more keywords, key phrases, categories or taxonomies, use advance search for inputting, selecting, updating and setting or applying one or more criteria, browsing directories or taxonomy wise, order or sort by date & time, source profile related one or more attributes including gender, age range, qualification, location, occupation, school, college and like, ascending or descending chronological orders, show bookmarked, most rated, most viewed, most commented, most liked 1005. Users can dynamically hide, show, attach or detach, remove, group, add to categories or group, order, add one or more posts in presented posts.

FIG. 11 illustrates Graphical User Interface (GUI) for enabling user to view, access & manage list of user's posts 1133 and shared or published or broadcasted contents or posted or shared or published or broadcasted contents for one or more keywords, key phrases, categories or taxonomies 1141, 1152, 1156, so user's followers and viewing users can receive, access & view user's posted or shared or published or broadcasted contents. Users can view various statistics related to posted or shared or published or broadcasted contents including number of viewers, views, followers, re-sharing comments, likes, rank or ratings 1146. In another embodiment users can update posted or shared or published or broadcasted contents 1146. In another embodiment enabling user to allow others or invite to update user's one or more or user's one or more keywords, key phrases, categories or taxonomies specific posted or shared or published or broadcasted contents and view, access, edit, update, remove, like, comment, rate said collaboratively updated contents. In another embodiment user can allow others to follow user's one or more keywords, key phrases, categories or taxonomies specific posted or shared or published or broadcasted one or more types of contents 1117, follow user 1119, follow user specific suggested keywords, key phrases, categories or taxonomies 1123 or sources or users 1127.

FIG. 12 illustrates Graphical User Interface (GUI) for enabling user to view, access & manage list of user's and/or user's one or more keywords, key phrases, categories or taxonomies related posted or shared or published or broadcasted contents specific viewers, associate detail, profile link, number of posts viewed by viewer, followed user or user's one or more keywords, key phrases, categories or taxonomies specific user's posted or shared or published or broadcasted contents, number of likes, comments, ratings by viewer on viewed posts or posted or shared or published or broadcasted contents of user, accessible lists of user's posts or posted or shared or published or broadcasted contents viewed by viewer, number & highlighted content of updates by viewer on user's post 1241, 1252, 1256, 1273. In another embodiment user is enable to follow viewer, follow following users, followers & viewers of viewer, follow one or more keywords, key phrases, categories or taxonomies of viewer 1246, invite viewer and add to contacts, invite viewer for collaborative updates, get feedbacks, ask for interactive forms, bookmark, group, categories, rank, filter, sort viewers, view various statistics based on viewers' profile, logs, user data including type of viewers comprises viewers of particular schools or college or age range or gender, demographics, locations related statistics of viewers.

FIG. 13 illustrates Graphical User Interface (GUI) for enabling user to view, access & manage following user of user and/or following user's one or more keywords, key phrases, categories or taxonomies specific posted or shared or published or broadcasted one or more types of contents 1341, 1352, 1356, 1373. In another embodiment user is enable to pause, stop and re-start receiving of posted or shared or published or broadcasted one or more types of contents said following users and/or following user's one or more keywords, key phrases, categories or taxonomies specific posted or shared or published or broadcasted one or more types of contents 1301. In another embodiment user is enable to view following users' profile, un-follow following users, follow following users, followers & viewers of following users, un-follow one or more keywords, key phrases, categories or taxonomies of following users, accept invitation of following users and allow them to add to contacts, accept invitation of following users for collaborative updates, provide feedbacks, submit interactive forms, bookmark, group, categories, rank, filter, sort following users, view various statistics based on following users' profile, logs, user data including type of following users comprises following users of particular schools or college or age range or gender, demographics, interest, occupation, qualification, expertise, locations related statistics of following users.

FIG. 14 illustrates Graphical User Interface (GUI) for enabling user to view, access & manage followers of user and/or followers of user's one or more keywords, key phrases, categories or taxonomies specific posted or shared or published or broadcasted one or more types of contents 1441, 1452, 1456, 1473. In another embodiment user is enable to view follower users' profile, follow followers, follow following users, followers & viewers of followers, follow one or more keywords, key phrases, categories or taxonomies of followers, invite or accept invitation of followers users and add or allow them to add user to their contacts, invite followers for collaborative updates, ask for feedbacks, ask to submit forms, bookmark, group, categories, rank, filter, sort followers, view various statistics based on followers' profile, logs, user data including type of followers comprises followers related to particular schools or college or age range or gender, demographics, interest, occupation, qualification, expertise, locations related statistics of followers.

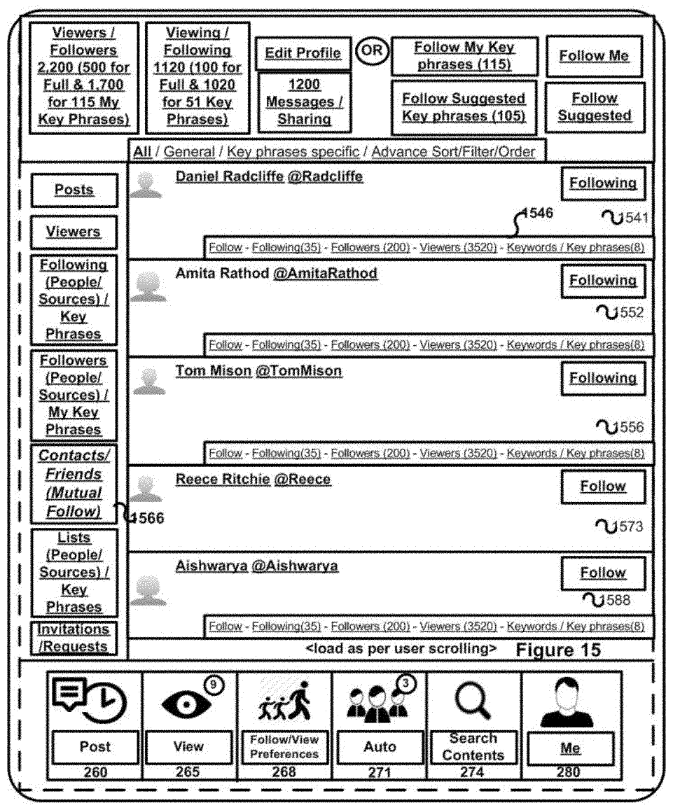

FIG. 15 illustrates Graphical User Interface (GUI) for enabling user to view, access & manage contacts of user 1541, 1552, 1556, 1573. In another embodiment user is enable to view contact users' profile, follow contacts, follow following users, followers & viewers of contacts, follow one or more keywords, key phrases, categories or taxonomies of contacts, invite contacts for collaborative updates, ask for & provide feedbacks, ask to submit forms or submit forms, bookmark, group, categories, rank, filter, sort contacts, view various statistics based on contacts' profile, logs, user data including type of contacts comprises contacts related to particular schools or college or age range or gender, demographics, interest, occupation, qualification, expertise, locations related statistics of contacts.

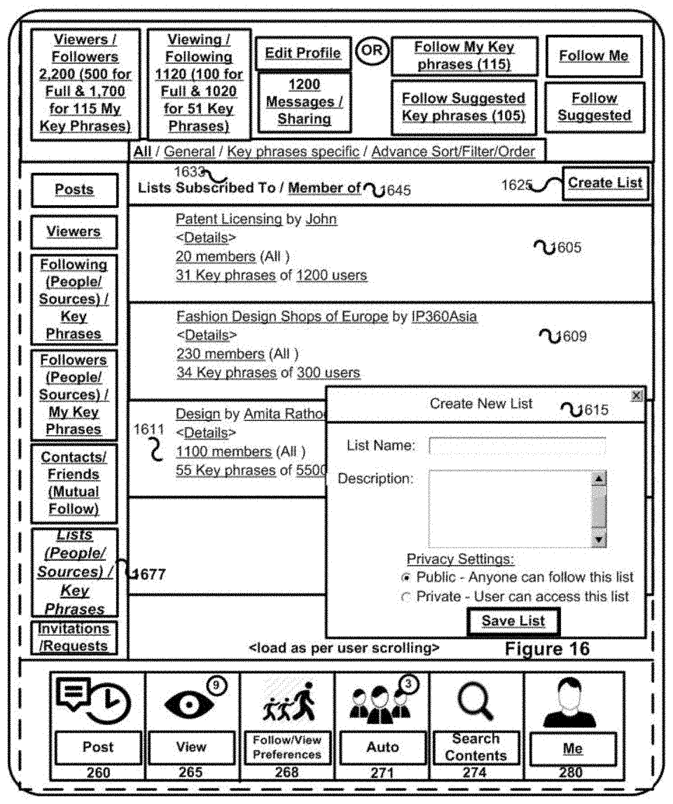

FIG. 16 illustrates Graphical User Interface (GUI) for enabling user to create list(s) 1625 & 1615, wherein user can enter the name of list, a short description of the list, and make list as private (only accessible to user) or public (anyone can subscribe to the list) 1615. A list is a curated group of users and/or their keywords, key phrases, categories or taxonomies 1605, 1609 & 1611. Users can create their own lists or subscribe to lists created by others. Viewing a list timeline will show a stream of posted or shared or published or broadcasted one or more types of contents from only the users and/or their keywords, key phrases, categories or taxonomies on that list. Users can add or remove people or users or accounts and/or one or more their keywords, key phrases, categories or taxonomies from the user's selected list(s). Users can view lists that users are on via clicking on “Member of” 1645. This will show what lists user and/or user's one or more keywords, key phrases, categories or taxonomies are on. User can view and access posted or shared or published or broadcasted one or more types of contents from a selected list(s), wherein user can see a timeline of posted or shared or published or broadcasted one or more types of contents from the users and/or their one or more followed keywords, key phrases, categories or taxonomies specific contents included in that list. Users can edit or delete one or more user created lists. Users can see lists users have created and other people's lists that users follow under “Subscribed to” 1633. User cannot add or remove people or users from the user's list, users must do that from the profile pages of each individual or each individual's one or more keywords, key phrases, categories or taxonomies the user wishes to add or remove. Users can subscribe to/follow other user's or people's lists via clicking on lists when viewing someone's profile and select one or more list users like to subscribe to or from the list page, click subscribe to follow the list. Users can follow lists without following the individual users in that list.

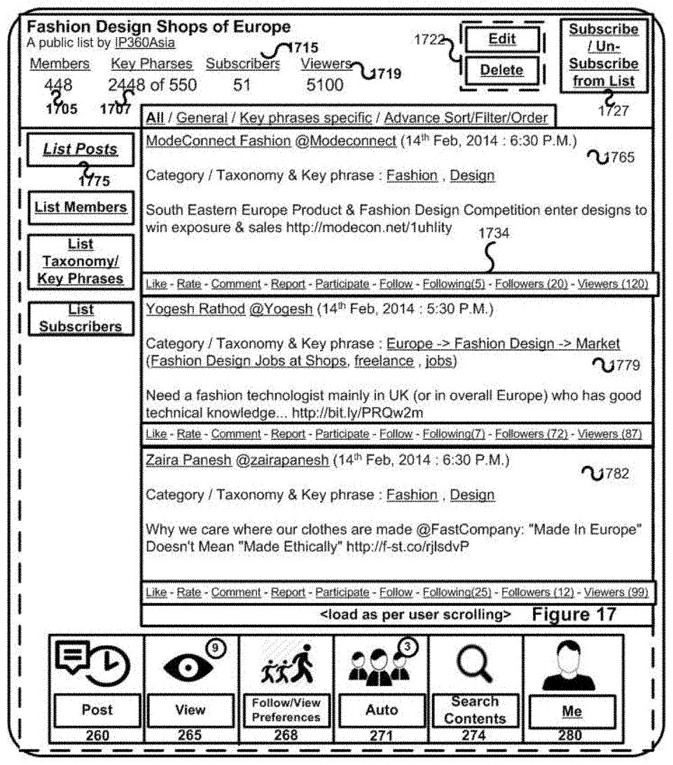

FIG. 17 illustrates Graphical User Interface (GUI) for enabling user to view list specific received posts or shared contents from list members and/or list associate one or more keywords, key phrases, categories or taxonomies specific posted or shared contents 1765, 1779, 1782. Users can view, access & follow list associate members 1705, key phrases or keywords or categories or taxonomies 1707, viewers 1719 and subscribers 1715. Users can subscribe or unsubscribe from list 1727. Users can edit or remove user's list 1722. User can follow post or shared contents associate source and/or one or more keywords, key phrases, categories or taxonomies, user can follow one or more selected followers, following users & viewing users, user can report, rate, like, provide comments, re-share one or more posts or shared contents 1734.

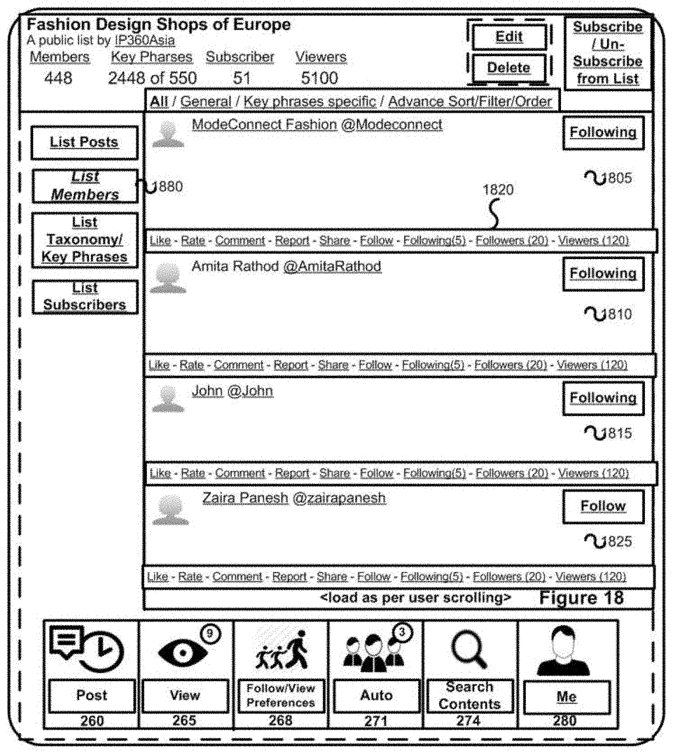

FIG. 18 illustrates Graphical User Interface (GUI) for enabling users to view, access & follow list associate members 1805, 1810, 1815, 1825. User can follow one or more selected followers, following users & viewing users of list associate members, user can report, rate, like, provide comments, share one or more list associate members 1805, 1810, 1815, 1825.

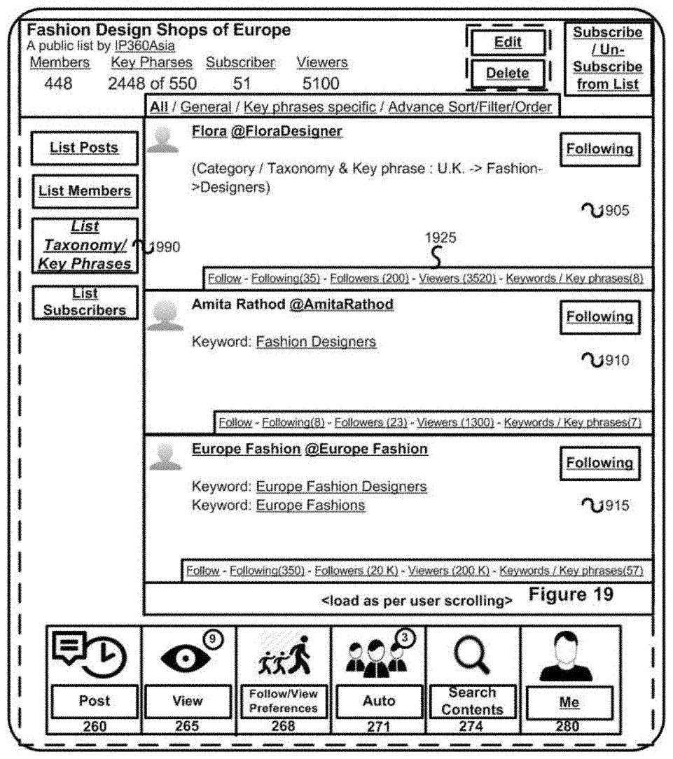

FIG. 19 illustrates Graphical User Interface (GUI) for enabling user to view, access & follow list associate one or more keywords, key phrases, categories or taxonomies 1905, 1910, 1915. User can follow one or more selected followers, following users & viewing users of list associate one or more keywords, key phrases, categories or taxonomies, user can also follow similar keywords, key phrases, categories or taxonomies of list associate one or more keywords, key phrases, categories or taxonomies, user can report, rate, like, provide comments, share one or more list associate one or more keywords, key phrases, categories or taxonomies 1905, 1910, 1915.

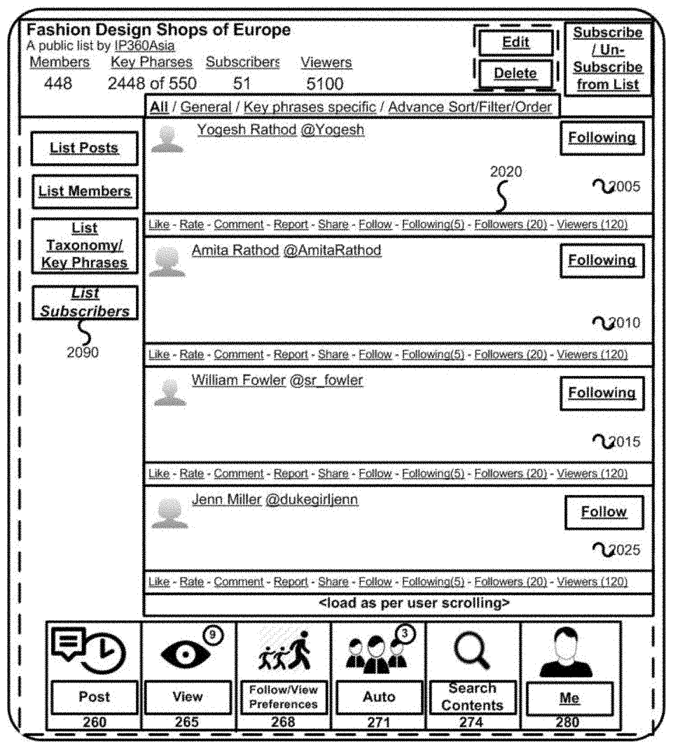

FIG. 20 illustrates Graphical User Interface (GUI) for enabling users to view, access & follow subscribers of list 2005, 2010, 2015, 2025. Users can follow one or more selected followers, following users & viewing users of subscribers of list, user can report, rate, like, provide comments, share one or more list associate subscribers 2005, 2010, 2015, 2025.

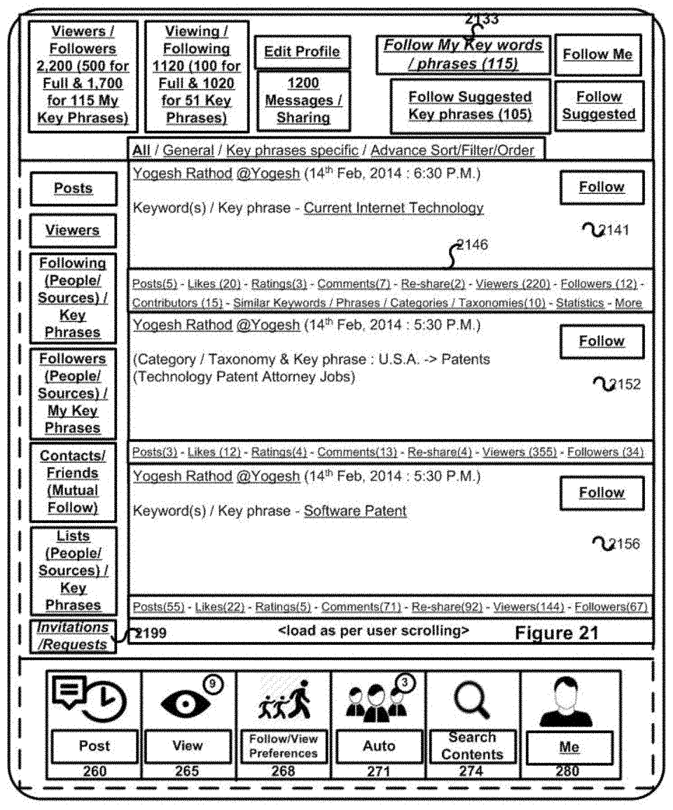

FIG. 21 illustrates Graphical User Interface (GUI) for enabling users of a network to user's one or more keywords, key phrases, categories or taxonomies 2141, 2152, 2156. Users and other users of the network can view one or more keywords, key phrases, categories or taxonomies specific posts or shared contents, view associate likes, ratings, comments viewers, followers 2146. Users of network can follow one or more selected followers including users and/or one or more keywords, key phrases, categories or taxonomies, following users and/or one or more keywords, key phrases, categories or taxonomies, contributors & viewing users of one or more keywords, key phrases, categories or taxonomies specific posts or shared contents, user can also follow similar keywords, key phrases, categories or taxonomies of user's one or more keywords, key phrases, categories or taxonomies, user can report, rate, like, provide comments, share one or more keywords, key phrases, categories or taxonomies 2146. In another embodiment enabling other users of network to send request(s) 2199 to user for participate in and/or enabling user to invite users of network and enabling other users of network to accept invitations to add, modify, remove, update, enhance, accumulate, curate, edit, draft, capture or collect media, collaboratively update, plan, organize, suggest, verify, validate one or more keywords, key phrases, categories or taxonomies specific one or more types of contents for posting under or for said one or more keywords, key phrases, categories or taxonomies, so users or viewers or followers of network can receive, view, access said posted or published or broadcasted shared contents.

FIG. 22 illustrates Graphical User Interface (GUI) for enabling user to provide, set, apply, input, select & update one or more types of settings including presentation settings, posting or sharing or publishing or broadcasting settings, participation or contribution settings, privacy settings, preferences and other types of settings. Users are enabled to set various presentation modes or styles 2205 including list style, television style, grid style, tabular style, slide show, tree style of presenting received or followed or preferences specific received or request(s) specific received or auto received posts or shared contents. User can apply or set ephemeral settings including once watch or view, view for particular period of time, do not repeat, do not present duplicate, present only for particular period of time, present only current or present posts or shared contents which generates or created or updated or posted or received within particular period of time 2207. Users are enabled to set or select auto open link(s) associate to selected post option 2213. User is enabling to use view planner 2219 for selecting various settings to view selected or particular type of sources or users or people and/or one or more keywords, key phrases, categories or taxonomies specific received posts or shared contents at particular date & time and date & time ranges or as per scheduling or present in random order or present in default chronological order or present in customized groups or categories or one or more keywords, key phrases, categories or taxonomies specific or present pre-specific order of one or more keywords, phrases, categories or group(s) or set(s) of categories and/or sources specific 2243 or present as per one or more criteria, sort order or filter settings and any combination thereof. In another embodiment user is enabled to start, pause, cancel or stop, re-start, attach, detach, combine, group, categories, hide & show preferred one or more sources, keywords, phrases & categories specific followed or viewed or received posted or shared contents. In another embodiment user is enable to provide updated availability status, status, updates availability date & time range(s) and presence information 2233 for enabling user to auto receive matched posted or shared contents and/or enabling to receive invitations or requests from other users for inviting user to participate in one or more activities or actions or tasks or workflow associate with identifying, drafting, updating, collaboratively updating, inputting, selecting, capturing, importing, inserting, reviewing, composing, modeling, ordering, rating, associating metadata & similar one or more keywords, key phrases, categories or taxonomies, planning, organizing, formatting, indexing, editing, searching, matching, curating, categorizing, preparing, verifying, validating, proofing, spell checking of one or more types of contents related to one or more source and/or keywords, key phrases, categories & taxonomies. In another embodiment user can select one or more participation types including updating, contributing, suggesting, reviewing, formatting, managing, editing contents, communicating, updating with others, accept real-time field or domain or subject specific requests, providing answers, referring, commenting, suggesting, selling, presenting, marketing, supporting one or more products & services, provide particular type of or structured contents, fill-up forms, survey forms, interactive or custom forms and like 2258. Users are also enabled to provide availability date & time, scheduling for fulfilling said participated tasks or activities 2272. Users are also enabled to search, match, select, download, install, subscribe, make payment, link, associate, use & access one or more applications, services, interfaces, contents & widgets for conducting & managing said selected participated one or more tasks or activities or actions or transactions or events. In another embodiment user is enable to apply one or more privacy settings to posting or sharing of contents including send or post or publish or broadcast one or more selected types of contents to contacts, friends, friends of friends, groups, one or more categories specific users or contacts, followers, viewers, selected users or contacts, selected one or more sources or destinations and make it private or public 2251. Users are also enabled to provide matchmaking broader preferences including receive posted or shared contents based on preferences and/or user data and/or customize privacy settings.

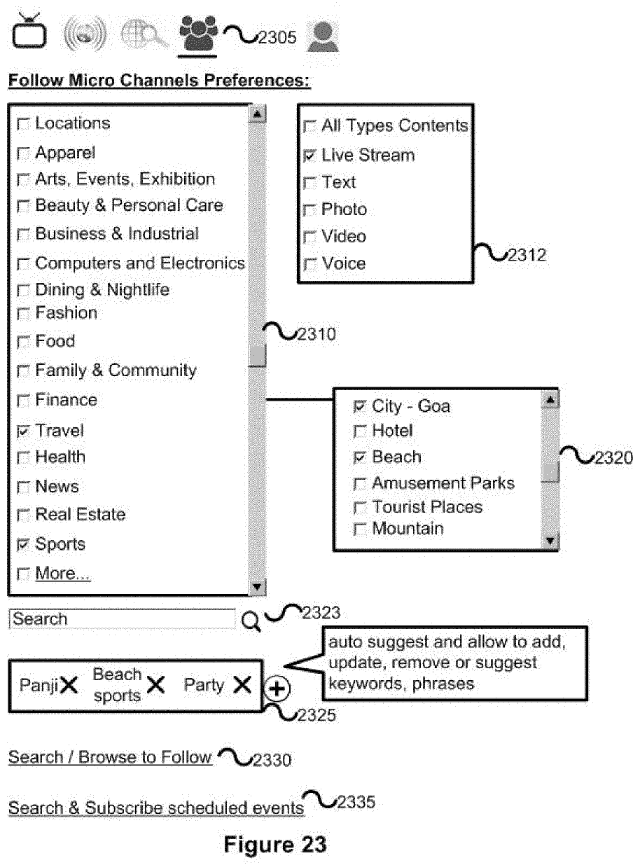

FIG. 23 illustrates exemplary graphical user interface (GUI) for enabling users to search 2323, match, browse 2310 & select various micro-channels to receive all or one or more selected types 2312 of live media or contents. Users can also select keywords 2325 with micro channels so users can prioritize in receiving selected keyword specific contents then other contents in same selected micro channels. Users can also search, match, browse, select and subscribe or follow 2330 one or more sources to receive or view said selected subscribed source(s) specific one or more types of live contents or media. Users can also search, match, browse, select and subscribe or follow 2335 one or more scheduled broadcastings of one or more types of live content or media.

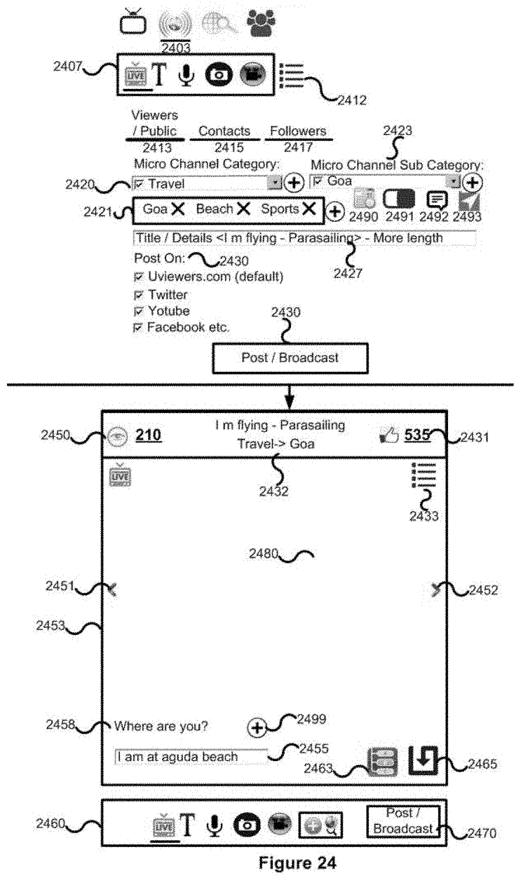

FIG. 24 illustrates exemplary graphical user interface (GUI) for enabling users to broadcast or post one or more selected types of contents for live contextual viewers. Users can select the type of content 2407 that users want to broadcast or post including streaming video, streaming audio, video, audio, photo & text and combination thereof. Users can select type of target viewers including viewers or subscribers 2413 of micro channels, contacts including phone book contacts, Facebook friends, selective twitter followers 2415, followers including 3rd parties' followers 2417 and any combination thereof. Users can search, match, and select micro channels 2420/2423 under which users want to broadcast or post contents. Users can search, browse, add or suggest, input or select or tag 2421 one or more contextual keywords related to contents. Users can schedule broadcasting or posting of contents 2490. Users can hide or show the user's identity to viewers or show only the nickname 2491. User can enable or disable or show or hide chat interface or one or more types of other interface or application or set of controls 2492 for enabling broadcasting or posting users and viewers to provide comments or share information or take one or more actions on contents including like, dislike, ratings, book, purchase, subscribe, buy. Users can also show or hide location and/or current or selective place(s) 2493. Users can provide title or details of broadcasted to posted contents 2427. Users can broadcast or post contents at one or more destinations including web sites, web pages, applications, interfaces, devices, servers, databases or storage medium & networks. When the user selects live streaming (streaming video, streaming audio) then the broadcast button enables and the user is presented with a camera display so the user can capture live video which are broadcasted to contextual viewers related to selected micro channels 2420/2423/2421. Users can search, select, view, access, remove, update, re-broadcast or re-post saved past contents 2412/2433. In an embodiment when the internet is not available then broadcast live video stores at local devices and when internet available then broadcast to viewers within a particular set period of time or duration. Based on type of content selection 2407 related interface 2453 is presented to users including e.g. text editor or text box for text type, camera display for capturing photo or recording video or live streaming video, sound or voice record interface for recording or live broadcasting or posting audio. After broadcasting or posting of content users can view number of viewers 2450, number of likes 2431, title or details 2432, chat conversation 2455/2558 related to said broadcasted or posted content item(s) e.g. 2480. Users can update one or more micro channels, categories, keywords, key phrases 2463 to make it more contextual for viewers. Users can further broadcast or post contents 2407. User can view one or more selective types 2460 of other broadcasted content item(s) 2451/2452 and view number of viewers 2450, number of likes 2431, title or details 2432, chat conversation 2455/2558 related to said broadcasted or posted content item(s) e.g. 2480. Users can save 2465 broadcasted or posted content item(s). In an embodiment broadcaster or posting user can search, match, make payment, download, install, upload, certify, register, select, customize or configure, attach or post one or more links of objects or applications or user actions or one or more or set of controls including button to access object or web service(s) or interface(s) or form(s) with broadcasted or posted contents or chat e.g. buy button, donate to broadcaster, surveying viewing user(s), order, subscribe, refer, as queries etc.

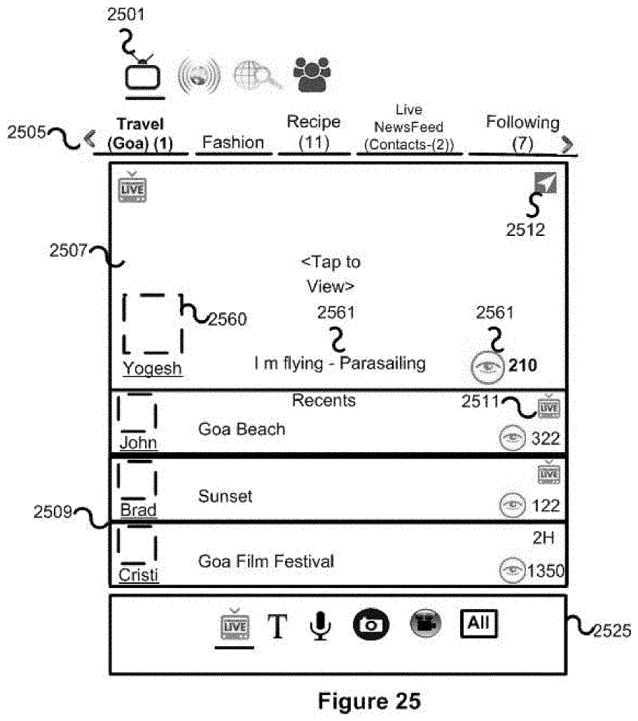

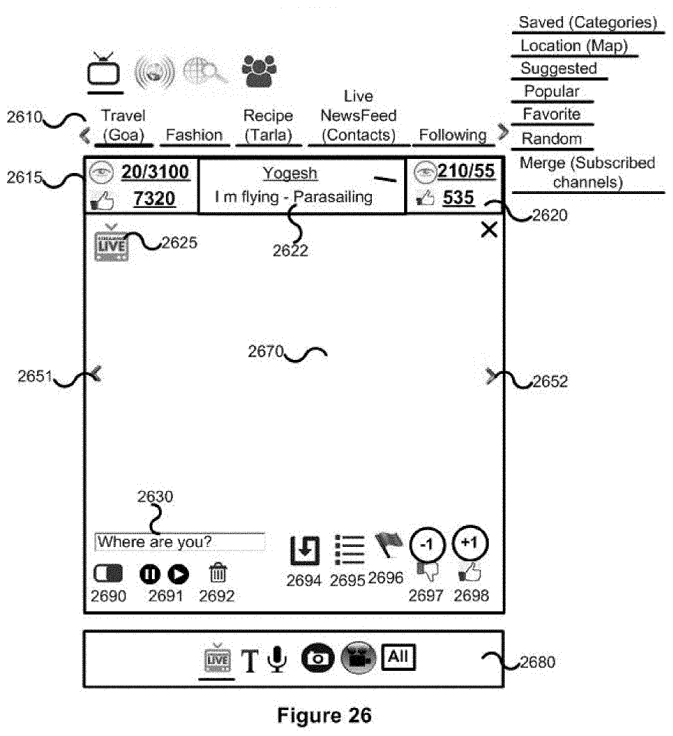

FIG. 25 illustrates exemplary graphical user interface (GUI) for enabling users to access a list of selected micro channel(s) specific live contents. User can view subscribed (discuss in detail in FIG. 23) or selected or added or auto presented micro channel(s) and/or keywords and/or contact(s) and/or followed user(s) 2505 specific one or more types of one or more content item(s) from one or more user(s) of network(s) or source(s). In an embodiment user is notified about arrival or receiving of new content item(s) related to all or selected or auto matched or subscribed micro channels and/or keywords and/or contact(s) and/or followed user(s). In an embodiment presented contents are not older than a particular period of time or duration. In an embodiment user can access list 2509 of said micro channel(s) and/or keywords and/or contact(s) and/or followed user(s) 2505 specific one or more types of one or more content item(s) e.g. 2507. In an embodiment most recent, most viewed or liked content item(s) will show top in list for attracting more viewers for quality content item(s) & recent content item(s). In an embodiment user can filter one or more types of contents or any combination thereof 2525 to view. In an embodiment user can filter contents as per current location or place(s) and/or selected locations or place(s) 2512. User can view content item specific posting or broadcasting user's photo, profile link & name or nickname or source name 2560, title & details 2561, number of viewers & likes 2561, date & time, preview or still image, associate metadata, keywords, categories, sub-categories & key phrases, content type icon 2511. Users can tap or click on a content item to view selected contents (discuss in detail in FIG. 26). In an embodiment when the internet is not available then users can locally download selective list item associate content item(s) when internet is available and can view later or within a set period of time or duration.

FIG. 26 illustrates exemplary graphical user interface (GUI) for enabling user to view, play, pause, remove from user's list, reply, skip, save, like, dislike, comment one or more type of live content(s) or media including live streaming video, streaming audio, video, photo, audio, text and any combination thereof. Users can view selected list item e.g. 2507 from list e.g. 2509 or can view latest or most liked & latest micro channel e.g. 2610 specific content item e.g. 2670. User can access & view subscribed, selected, auto matched, auto presented, contact(s) related, suggested, location(s) or place(s) specific, popular, random, saved, bookmarked, liked, past or logged, favorite, keyword(s) or key phrase(s) related micro channels 2610. User can view total number of content items, total number of viewers related to selected or current micro channel e.g. (Travel-Goa 2610) within particular period of time or duration, User can also view number of total points/likes of all viewers related to selected or current micro channel e.g. (Travel-Goa 2610) within a particular period of time or duration, number of viewers, number of Live Viewers, Points/Likes, Time watched, Duration, Retention (local save). Users can view selected items and the latest content item. Users can skip, view previous 2651 or next 2652 content items within a particular period of time or duration. Users can filter one or more types of content 2680 to view contents. Users can show or hide 2690 chats or one or more type(s) of applications or interfaces or set of controls on content item(s). User can play or pause streaming video, streaming audio or video 2691, delete 2692 content item or delete reply, user can save content item e.g. 2670 locally 2694, bookmark source, viewing user can tag content item(s), search, match, select, access & view list of content items related to micro channels 2695 i.e. list 2509, report content as spam, copyrighted or other's content, non-contextual, not good quality & inappropriate 2696, user can give one or more likes 2698 or dislike(s) 2697. In an embodiment auto next when current streaming video, streaming audio or video ends.

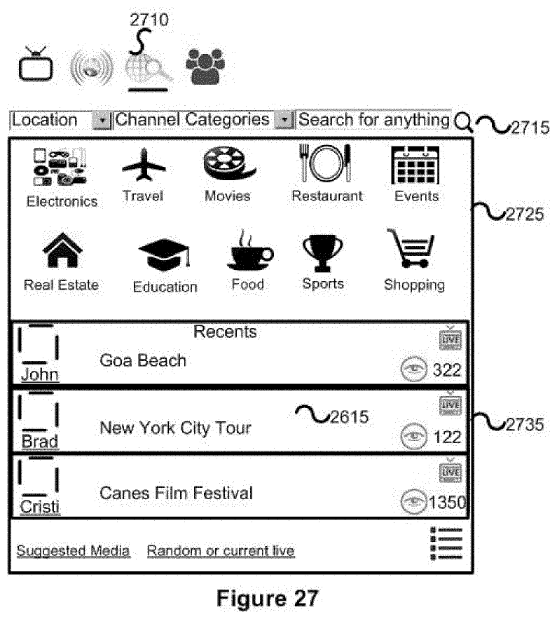

FIG. 27 illustrates exemplary graphical user interface (GUI) for enabling user to search 2715, location wise search match, select, bookmark, access, browse live micro channel and/or associate keywords or key phrases and view selected micro channel specific live one or more types of media or contents.

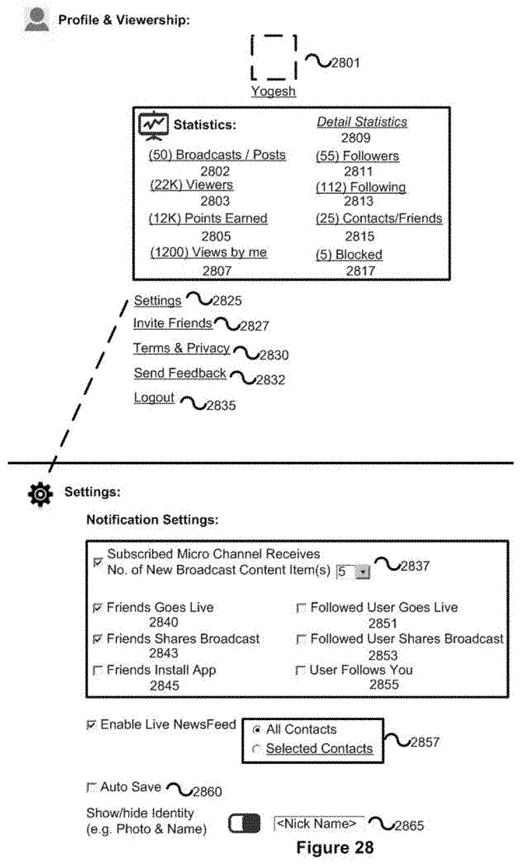

FIG. 28 illustrates exemplary graphical user interface (GUI) for enabling users to view various types of statistics and apply various settings. Users can access, view, update, apply privacy settings to view the user's profile by others & share user profile 2801. User can view various statistics including number of broadcasted or posted content item(s) 2802 which further comprise list of all broadcasted or posted content items details including date & time, locally saved content item, type of content item, title or description, number of viewers & likes or dislikes of each content item 2802, number of total viewers 2803 which further includes detail statistics including location wise, micro channel wise, keyword wise viewers, duration of views, date & time wise, date & time range(s) wise viewers 2803, total points earned or total balance points or total likes earned 2805, total number of content items views by user which further comprise list of all viewed & saved content items details including date & time, locally saved content item, type of content item, source name or nickname, related total viewers, views, likes & dislikes, title or description, number of views & likes or dislikes of each content item 2807, statistics including date wise, location wise, micro channel wise, keyword wise, content type wise views. Users can also view micro channel wise detail statistics 2809 to find most popular content items, content type(s), content sources, micro channels, keywords, location of viewers. Users can view the total number of followers 2811 which further includes name or nickname or profile details of followers. Users can view the total number of following users 2811 which further includes name or nick name or profile details of following users. Users can view a list of friends or contacts 2815 including phone book contacts, Facebook friends, contacts related to one or more 3rd parties websites, applications, web services, social networks & like.

User can access, set, apply, update, input, select one or more types of privacy settings including notification settings comprise receive notification when new content item broadcasted or posted under subscribed micro channels 2837 or receive notification only when set particular number of new content items broadcasted or posted under subscribed micro channels 2837, receive notification when Friends Goes Live 2840, receive notification when Friends Shares Broadcast 2843, receive notification when Friends Install App 2845, receive notification when Followed User Goes Live 2851, receive notification when Followed User Shares Broadcast 2853 and receive notification when User Follows You 2855. Users can enable Live NewsFeed 2857 for all contacts or selected contacts only, so all or selected contacts only can view the user's broadcasted or posted content item(s). Users can on or off Auto Save 2860 to save all viewed contents or save each manually from the interface. Users can show or hide the user's Identity (e.g. photo, profile details, status, location, check in or selected place, last seen & name) 2865.

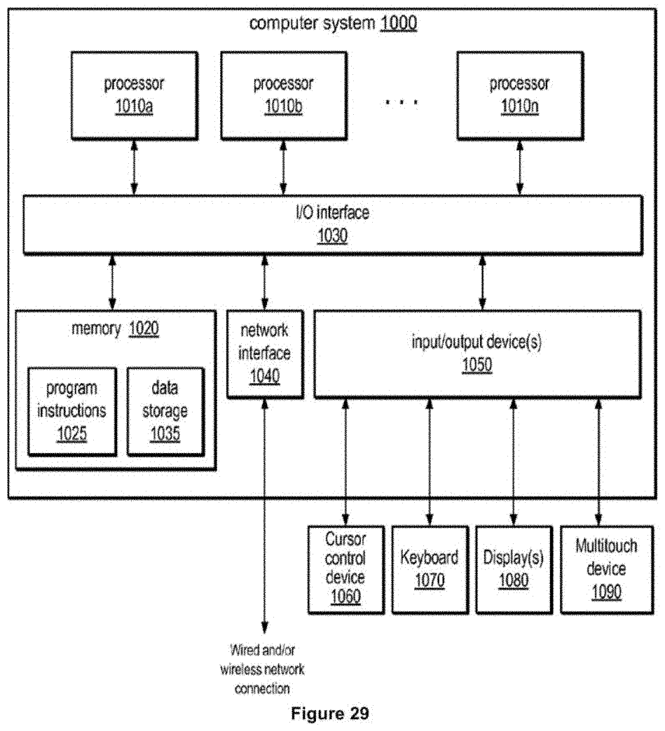

Various components of embodiments of methods as illustrated and described in the accompanying description may be executed on one or more computer systems, which may interact with various other devices. One such computer system is illustrated by FIG. 29. In different embodiments, computer system 1000 may be any of various types of devices, including, but not limited to, a personal computer system, desktop computer, laptop, notebook, or notebook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In the illustrated embodiment, computer system 1000 includes one or more processors 1010 coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, multitouch device 1090, and display(s) 1080. In some embodiments, it is contemplated that embodiments may be implemented using a single instance of computer system 1000, while in other embodiments multiple such systems, or multiple nodes making up computer system 1000, may be configured to host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 1010, or a multiprocessor system including several processors 1010 (e.g., two, four, eight, or another suitable number). Processors 1010 may be any suitable processor capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA.

In some embodiments, at least one processor 1010 may be a graphics processing unit. A graphics processing unit or GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the methods as illustrated and described in the accompanying description may be implemented by program instructions configured for execution on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies, and others.

System memory 1020 may be configured to store program instructions and/or data accessible by processor 1010. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those for methods as illustrated and described in the accompanying description, are shown stored within system memory 1020 as program instructions 1025 and data storage 1035, respectively. In other embodiments, program instructions and/or data may be received, sent or stored upon different types of computer-accessible media or on similar media separate from system memory 1020 or computer system 1000. Generally speaking, a computer-accessible medium may include storage media or memory media such as magnetic or optical media, e.g., disk or CD/DVD-ROM coupled to computer system 1000 via I/O interface 1030. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 1040.

In one embodiment, I/O interface 1030 may be configured to coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. In addition, in some embodiments some or all of the functionality of I/O interface 1030, such as an interface to system memory 1020, may be incorporated directly into processor 1010.

Network interface 1040 may be configured to allow data to be exchanged between computer system 1000 and other devices attached to a network, such as other computer systems, or between nodes of computer system 1000. In various embodiments, network interface 1040 may support communication via wired and/or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 1050 may, in some embodiments, include one or more display terminals, keyboards, keypads, touchpads, scanning devices, voice or optical recognition devices, or any other devices suitable for entering or retrieving data by one or more computer system 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired and/or wireless connection, such as over network interface 1040.

As shown in FIG. 29, memory 1020 may include program instructions 1025, configured to implement embodiments of methods as illustrated and described in the accompanying description, and data storage 1035, comprising various data accessible by program instructions 1025. In one embodiment, program instruction 1025 may include software elements of methods as illustrated and described in the accompanying description. Data storage 1035 may include data that may be used in embodiments. In other embodiments, other or different software elements and/or data may be included.

Those skilled in the art will appreciate that computer system 1000 is merely illustrative and is not intended to limit the scope of methods as illustrated and described in the accompanying description. In particular, the computer system and devices may include any combination of hardware or software that can perform the indicated functions, including computers, network devices, internet appliances, PDAs, wireless phones, pagers, etc. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent examples of embodiments of methods. The methods may be implemented in software, hardware, or a combination thereof. The order of method may be changed, and various elements may be added, reordered, combined, omitted, modified, etc. Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

In an embodiment a program is written as a series of human understandable computer instructions that can be read by a compiler and linker, and translated into machine code so that a computer can understand and run it. A program is a list of instructions written in a programming language that is used to control the behavior of a machine, often a computer (in this case it is known as a computer program). A programming language's surface form is known as its syntax. Most programming languages are purely textual; they use sequences of text including words, numbers, and punctuation, much like written natural languages. On the other hand, there are some programming languages which are more graphical in nature, using visual relationships between symbols to specify a program. In computer science, the syntax of a computer language is the set of rules that defines the combinations of symbols that are considered to be a correctly structured document or fragment in that language. This applies both to programming languages, where the document represents source code, and markup languages, where the document represents data. The syntax of a language defines its surface form. Text-based computer languages are based on sequences of characters, while visual programming languages are based on the spatial layout and connections between symbols (which may be textual or graphical or flowchart(s)). Documents that are syntactically invalid are said to have a syntax error. Syntax—the form—is contrasted with semantics—the meaning. In processing computer languages, semantic processing generally comes after syntactic processing, but in some cases semantic processing is necessary for complete syntactic analysis, and these are done together or concurrently. In a compiler, the syntactic analysis comprises the frontend, while semantic analysis comprises the backend (and middle end, if this phase is distinguished). There are millions of possible combinations, sequences, ordering, permutations & formations of inputs, interpretations, and outputs or outcomes of set of instructions of standardized or specialized or generalized or structured or functional or object oriented programming language(s).

The present invention has been described in particular detail with respect to a limited number of embodiments. Those of skill in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Furthermore, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component. Additionally, although the foregoing embodiments have been described in the context of a social network website, it will apparent to one of ordinary skill in the art that the invention may be used with any social network service, even if it is not provided through a website. Any system that provides social networking functionality can be used in accordance with the present invention even if it relies, for example, on e-mail, instant messaging or any other form of peer-to-peer communications, or any other technique for communicating between users. Systems used to provide social networking functionality include a distributed computing system, client-side code modules or plug-ins, client-server architecture, a peer-to peer communication system or other systems. The invention is thus not limited to any particular type of communication system, network, protocol, format or application.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

I claim:

1. A method of user to user live broadcasting or posting or sharing or live viewing comprising:
enabling broadcasting and sharing user to broadcast or share or send or post one or more types of media including streaming video, streaming audio, text, voice, photo & video under one or more selected pre-defined micro channels;
enabling viewing user to access or set auto select mode to view or select or subscribe one or more said pre-defined micro channels to receive & view said broadcasted or shared or posted media or contents; and
enabling viewing user to view said posted or broadcasted contents as and when they posted or broadcasted or enabling to real-time notify or real-time view or real-time view after acceptance of notification or view within particular duration said auto selected or preferred or most liked or subscribed one or more pre-defined micro channels specific one or more types of media including live stream, text, voice, photo & video from one or more broadcasters or sharing or posting users of network.

2. The method of claim 1, wherein enabling user to input, suggest, add, update & select one or more keywords with one or more selected micro channels.

3. The method of claim 1, wherein enabling user to input, suggest, add, update & select one or more keywords with one or more broadcasted or posted content item(s).

4. The method of claim 1, wherein prioritize in presenting real-time broadcasted contents to user based on match making of broadcasted or posted content item(s) associate keywords and subscribed micro channel related keywords by user.

5. The method of claim 1, wherein enabling user to search, match, browse, access, select, bookmark, watch later, save, refer, remove, replay, pause, stop, skip, record, fast forward or backward, schedule to start or play or present or pause, view next or previous, change orders of content items broadcasted within particular period of time or duration.

6. The method of claim 1, wherein enabling user to bookmark source of content item.

7. The method of claim 1, wherein prioritize in presenting real-time broadcasted contents to user based on said bookmarked source.

8. The method of claim 1, wherein prioritize in presenting real-time broadcasted contents to user based on number of likes, local saves, duration of views, views of viewers & any combination thereof.

9. The method of claim 1, wherein prioritize in presenting real-time broadcasted contents to user based on current location, check-in place(s), selected location(s), past location(s) of user and location mentioned in user's profile including home, school, company, office, employment address, travel addresses & like.

10. The method of claim 1, wherein prioritize in presenting real-time broadcasted contents to user based on identifying broadcasters within contacts and/or followers of user.

11. The method of claim 1, wherein queuing broadcasted or posted content items or ordering or adding or updating of content items in queue for presenting to each user or particular user or group of users or set of users or matched users or categories or type of user(s) based on user's preferences, subscribed micro channels, match making of broadcasted content item(s) associate keyword(s) with subscribed micro channel(s) associate keywords, key phrases, categories, sub-categories, taxonomy, ontology, number of views or viewers, time spent or duration, number of likes & number of local saves of content item(s), user data including user profile, locations, check-in place(s), status, activities, actions, senses, events, transactions, period of time of broadcasting of content item(s), current number of items of broadcasted content item(s) in particular micro channel(s or keyword(s), bookmarking of source(s), identification of broadcaster(s) as user's contact(s) and/or follower(s), verified sources, advertisers or registered enterprise users, date & time, date & time ranges, trends including identified trending keywords, current news, currently in popular or top list, users data retrieved from 3^{rd} parties web sites, applications, services, databases, networks & devices, most followed sources, most liked or most viewed users, searched, browsed, bookmarks, broadcasters falls in user's location(s), match making of broadcaster's profile data with viewers or user's profile data including age, gender, cast, qualification, income ranges, interest or hobbies, professional, type of job, school, college, company or one or more related or interacted entities and any other similarities, dynamically add or update or remove (e.g. copyrighted contents) by registered or authorized administrators or users or permitted contacts of user, update queue as per update in user preferences, update in micro channels subscriptions and update in associate keywords, removal of identified duplicate contents or viewed contents within particular period of time, applied or executed one or more rules, most latest content item, time zone of user.

12. The method of claim 1, wherein presented live contents comprises contextual user actions including like, buy, sell, order, book, refer to contacts, subscribe, surveying, ask quires button, form, application, interface, object, link, database access, check box(s), input box, radio button(s), list(s) or combo box(s) for selection and one or more type of controls.

13. The method of claim 1, wherein removing content items from queue based on content item view by user, remove after set period of time of broadcasting of content item(s), content item removed by user, content item removed by broadcaster.

14. A system of user to user live broadcasting or posting or sharing or live viewing comprising:
broadcasting and sharing user is enable to broadcast or share or send or post one or more types of media including streaming video, streaming audio, text, voice, photo & video under one or more selected pre-defined micro channels;
viewing user is enable to access or set auto select mode to view or select or subscribe one or more said pre-defined micro channels to receive & view said broadcasted or shared or posted media or contents; and
viewing user is enable to view said posted or broadcasted contents as and when they posted or broadcasted or enabling to real-time notify or real-time view or real-time view after acceptance of notification or view within particular duration said auto selected or preferred or most liked or subscribed one or more pre-defined micro channels specific one or more types of media including live stream, text, voice, photo & video from one or more broadcasters or sharing or posting users of network.

15. The system of claim 14, wherein user is enable to input, suggest, add, update & select one or more keywords with one or more selected micro channels.

16. The system of claim 14, wherein user is enable to input, suggest, add, update & select one or more keywords with one or more broadcasted or posted content item(s).

17. The system of claim 14, wherein a module configure to prioritize presenting of real-time broadcasted contents to user based on match making of broadcasted or posted content item(s) associate keywords and subscribed micro channel related keywords by user.

18. The system of claim 14, wherein user is enable to search, match, browse, access, select, bookmark, watch later, save, refer, remove, replay, pause, stop, skip, record, fast forward or backward, schedule to start or play or present or pause, view next or previous, change orders of content items broadcasted within particular period of time or duration.

19. The system of claim 14, wherein user is enable to bookmark source of content item.

20. The system of claim 14, wherein a module configure to prioritize presenting of real-time broadcasted contents to user based on said bookmarked source.

21. The system of claim 14, wherein a module configure to prioritize presenting of real-time broadcasted contents to user based on number of likes, local saves, duration of views, views of viewers & any combination thereof.

22. The system of claim 14, wherein a module configure to prioritize presenting of real-time broadcasted contents to user based on current location, check-in place(s), selected location(s), past location(s) of user and location mentioned in user's profile including home, school, company, office, employment address, travel addresses & like.

23. The system of claim 14, wherein a module configure to prioritize presenting of real-time broadcasted contents to user based on identifying broadcasters within contacts and/or followers of user.

24. The system of claim 14, wherein a module configure for queuing broadcasted or posted content items or ordering or adding or updating of content items in queue for presenting to each user or particular user or group of users or set of users or matched users or categories or type of user(s) based on user's preferences, subscribed micro channels, match making of broadcasted content item(s) associate keyword(s) with subscribed micro channel(s) associate keywords, key phrases, categories, sub-categories, taxonomy, ontology, number of views or viewers, time spent or duration, number of likes & number of local saves of content item(s), user data including user profile, locations, check-in place(s), status, activities, actions, senses, events, transactions, period of time of broadcasting of content item(s), current number of items of broadcasted content item(s) in particular micro channel(s or keyword(s), bookmarking of source(s), identification of broadcaster(s) as user's contact(s) and/or follower(s), verified sources, advertisers or registered enterprise users, date & time, date & time ranges, trends including identified trending keywords, current news, currently in popular or top list, users data retrieved from 3^{rd} parties web sites, applications, services, databases, networks & devices, most followed sources, most liked or most viewed users, searched, browsed, bookmarks, broadcasters falls in user's location(s), match making of broadcaster's profile data with viewers or user's profile data including age, gender, cast, qualification, income ranges, interest or hobbies, professional, type of job, school, college, company or one or more related or interacted entities and any other similarities, dynamically add or update or remove (e.g. copyrighted contents) by registered or authorized administrators or users or permitted contacts of user, update queue as per update in user preferences, update in micro channels subscriptions and update in associate keywords, removal of identified duplicate contents or viewed contents within particular period of time, applied or executed one or more rules, most latest content item, time zone of user.

25. The method of claim 14, wherein presented live contents comprises contextual user actions including like, buy, sell, order, book, refer to contacts, subscribe, surveying, ask quires button, form, application, interface, object, link, database access, check box(s), input box, radio button(s), list(s) or combo box(s) for selection and one or more type of controls.

26. The method of claim 14, wherein a module configure to remove content items from queue based on content item view by user, remove after set period of time of broadcasting of content item(s), content item removed by user, content item removed by broadcaster.

27. A method comprising:
enabling user(s) to input, select, edit, update & verify one or more keyword(s), wherein keyword enables posting users of network to select verified keywords at the time of posting contents under said keyword;
enabling user(s) to follow one or more keyword(s) for real-time receiving followed keyword(s) related posted contents;
enabling user(s) to post contents under one or more keyword(s);
store contents and associate keyword(s);
matching followed keyword(s) of user(s) with said posted contents associate keyword(s); and
presenting followed keyword(s) specific contents to keyword(s) follower(s).

28. The method of claim 27, wherein keyword(s) comprises one or more or group(s) of exact, matched, broader matched, alternative, similar keywords, sequence of words or characters, categories, sub-categories, taxonomies, names, named entities, nodes, items, locations, key phrases, ontology, semantic syntax, sentence.

29. The method of claim 27, wherein keyword matched based on exact match, broader match, narrow match, phrase match and similar matches.

30. The method of claim 27, wherein enabling viewing user to follow one or more keyword(s) associate followers.

31. The method of claim 27, wherein enabling viewing user to follow posted content associate viewers.

32. The method of claim 27, wherein enabling viewing user to follow posted content source(s).

33. The method of claim 27, wherein enabling viewing user to follow one or more followed keyword(s) related similar or alternative or matched other keyword(s).

34. The method of claim 27, wherein enabling viewing user to ignore one or more received posted contents associate keyword(s).

35. The method of claim 27, wherein enabling viewing user to ignore one or more received posted contents associate source(s).

36. The method of claim 27, wherein enabling users to create and update list(s) of keyword(s).

37. The method of claim 36, wherein enabling users to follow said one or more list(s) of keyword(s).

38. The method of claim 36, wherein enabling users to follow said one or more keywords from said one or more list(s) of keyword(s).

39. The method of claim 36, wherein enabling users to follow said one or more followers of said one or more list(s) of keyword(s).

40. The method of claim 27, wherein creating group(s) based on posting users and/or followers of similar types of keywords including exact, broader match, phrase match, alternative, related meaning associate keywords, rank, number of likes & comments and ratings, similar profiles, activities, actions, events, transactions, locations, check-in places, updates, status, presence information, connections, connected users' data and any combination thereof.

41. The method of claim 40, wherein enabling or instructing or suggesting said group(s) to share contents, enhance or expand posts, update posts, converse with each other.

42. The method of claim 27, wherein enabling users to share and refer one or more keywords for enabling receiving user to follow said shared or referred keywords.

43. The method of claim 27, wherein enabling posting users to target post to viewing users based on one or more criteria including locations, languages, IP addresses, user profile data or fields including age range, income range, education qualifications, user attributes including height, weight, color & like, cast, interests, preferences, privacy settings, rules, date & time, names, contacts, named entities, gender, employment type, business type, networks, type of user's activities, actions, events, senses, transactions, behavior, status and one or more or group(s) or list(s) of exact, broader matched, phrase match & similar keywords, key phrases, named entities, categories, & taxonomies associate followers & viewers and any combination thereof.

44. The method of claim 27, wherein enabling one or more keyword(s) specific posting users to follow each other and create group(s).

45. The method of claim 44, wherein enabling to collaboratively draft, compose, input, edit, admin, update one or more posts and share contents.

46. The method of claim 27, wherein enabling user to schedule posting and schedule presenting.

47. The method of claim 27, wherein enabling user to select, start, pause, re-start, hide, show & stop or un-follow receiving of followed keyword(s) specific contents.

48. The method of claim 27, wherein enabling user to search, match, select and invite users of network and/or searched posts or contents associate sources, viewers, followers & following users to follow or connect user(s).

49. The method of claim 27, wherein enabling user to search, match, select posted contents and follow selected posted content associate keyword(s).

50. The method of claim 27, wherein presenting to user matched & updated users related to user.

51. The method of claim 50, wherein presenting to user matched & updated users related to user based on preferences, privacy settings, rank or rating of user, number of current points, purchasing of target or contextual viewers, user connections, followers, following users, viewers, related or contextual exact, broader matched, phrase match, similar & matched keyword specific posting users, groups, followers, following users & viewers, profile, shared contents, user activities, logs, actions, events, interactions, senses, transactions, locations, checked-in places, behavior.

52. The method of claim 50, wherein enabling user to searching, matching, browsing, selecting users from presented matched & updated users related to user for inviting them to become follower of each other by accepting invitations.

53. The method of claim 52, wherein enabling user to apply settings for automatically un-follow mutually followed users when mutually followed users un-follow user(s).

54. The method of claim 27, wherein enabling user to follow one or more selected keywords of one or more source(s) or user(s) or posting user(s) or publisher(s) or broadcaster(s).

55. The method of claim 27, wherein enabling user to follow broader or parent keywords which includes child or child of child up-to tree like presented number of depths or set or collection or group(s) or list(s) of keywords including similar, related, curated, contextual, ontologically & semantically or meaning wise related keywords.

56. The method of claim 27, wherein enabling user to create list(s) of keywords including parent keyword(s) and associate child keyword(s), practically or semantically or ontologically or meaning wise related.

57. The method of claim 27, wherein verify keyword including check language, availability, meaning, similar, alternate, existence of keyword(s) and phrase(s).

58. The method of claim 57, wherein verification task assign to one or more ranked or verified users of network, administrator, verify & validate via software, web services, databases, online web sites, search engines.

59. The method of claim 27, wherein auto identify, attach, associate, relate, store, present, update one or more keywords, phrases, named entities, nodes, nodes of network, categories, taxonomies, ontology, metadata related to drafted, saved, edited, presented, selected, updated, posting or posted contents.

60. The method of claim 27, wherein present, update, identify suggested one or more keywords, phrases, named entities, nodes, nodes of network, categories, taxonomies, ontology, metadata related to drafted, saved, edited, presented, selected, updated, posting or posted contents.

61. The method of claim 60, wherein said post specific suggested keywords, phrases, named entities, nodes, nodes of network, categories, taxonomies, ontology, metadata are based on contents of post or drafted or updated or edited or presented or shared contents, meaning, similar or related or contextual, suggested by connected users, user profile, user data, connections, followers, following users, viewers, connected users' data, user logs, activities, actions, events, transactions, interactions, senses, locations, check-in places, updates, status, current trends, preferences, privacy settings, shared data & any combination thereof.

62. The method of claim 60, wherein enabling user to search, match, import, ask, browse, filter, select one or more suggested keywords for posting contents under said selected one or more keywords, phrases, named entities, nodes, nodes of network, categories, taxonomies, ontology, metadata.

63. The method of claim 27, wherein enabling user to select one or more keywords, phrases, named entities, nodes, nodes of network, categories, taxonomies, ontology, metadata related to drafted, saved, edited, presented, selected, updated, posting or posted contents.

64. The method of claim 27, wherein enabling user to create, collaboratively create & update one or more keywords, phrases, named entities, nodes, nodes of network, categories, taxonomies, ontology, metadata.

65. The method of claim 27, wherein enabling to receive, store, present, update, associate contextual, updated & real-time user generated contents or user posted contents to one or more keywords, phrases, named entities, nodes, nodes of network, categories, taxonomies, ontology, metadata related to one or more types of contents via APIs.

66. The method of claim 27 or 65, wherein enabling user to select or select from highlighted one or more keywords, phrases, named entities, nodes, nodes of network, categories, taxonomies, ontology, metadata from presented, searched, received one or more types of contents and presenting said selected or highlighted one or more keywords, phrases, named entities, nodes, nodes of network, categories, taxonomies, ontology, metadata specific user posted or updated contents.

67. The method of claim 65 or 66, wherein contents comprising contents of web page(s) or web site(s), drafted or edit contents, contents of application(s) or database(s) and one or more types of media including text, link, audio, image, photo, video, voice, voice to text, text detected from images or videos, file, document, application, object, user profile, named entities, keywords, phrases, named entities, locations, nodes, nodes of network, categories, taxonomies, ontology, metadata.

68. The method of claim 27, wherein enabling user to post contents to followers, viewers & connected users without selected one or more keywords, phrases, named entities, nodes, nodes of network, categories, taxonomies, ontology, metadata.

69. The method of claim 27, wherein suggesting or indicating user what to post including suggest or present or update one or more types of contents, invited for collaboratively drafted topic or subject or keyword, topics, trends, news, links, links of sources of contents including web sites, databases, past shared contents, contents from network, social network, user & connected users' profile(s) & related data.

70. The method of claim 69, wherein suggestion based on user drafted or inputted or selected or edited or updated or presented contents.

71. The method of claim 69, wherein suggestion based on based on user profile including fields and associate values like qualification, age, gender, location, type & name of employment or college or school & interests, user data, connections, followers, following users, viewers, connected users' data, user logs, activities, actions, events, transactions, interactions, senses, locations, check-in places, updates, status, current trends, preferences, privacy settings, shared data & any combination thereof.

72. The method of claim 27, wherein enabling to verified as well as anonymous user accounts, enterprise accounts, posts or shared contents, sources, publishers, following related keywords, key phrases, categories, taxonomies, lists, viewers, followers, following users, contacts or connections, provider of comments, ratings, & likes.

73. The method of claim 27, wherein enabling user to search, match, select, select from presented or suggested or auto matched, purchase, update, and customize structured contents for posting structured contents.

74. The method of claim 27, wherein structured contents or resources comprises domain or subject or keyword(s) or key phrase(s) specific forms, wizards, templates, fields and/or associate values, applications, custom forms, interfaces, widgets, set of controls, links, objects, functions, features, user actions, pre-created and/or customizable forms including profile, job requirements, job profile, survey forms, advertisements, group deals.

75. The method of claim 27, wherein enabling user to import, export, store & index to database, data mine, download, upload, subscribe, submit or re-submit filled forms, participate with interactive survey forms, follow, view, sort, filter, rank, rate, bookmark, group, list, categories, search & match based on one or more criteria, compare, calculate, process, analyze structured contents or resources.

76. The method of claim 27, wherein suggesting or instructing viewing users or followers to provide one or more types of structured or unstructured further details on one or more posts or shared contents.

77. The method of claim 76, wherein one or more types of structured or unstructured further details on one or more posts or shared contents comprises questions, answers, availability including locations, address, maps & directions, features, climate, price, comparison, similar posts or contents, related keywords, key phrases, categories, taxonomies & metadata, types of contents, properties, attributes, pre-created, presents & customized fields and associate values, edited or updated version of contents, enhancement of contents including related news, blogs, search results, links, photos, videos and like, one or more types of user actions including like, dis-like, buy, sell, purchased, interested, suggest, refer, bookmark, response, comments, rank, rate, vote, listen, play, recipe, emoticons.

78. The method of claim 27, wherein enabling keyword(s) or key phrase(s) specific viewers & followers to view real-time updated or posted or provided and past posts and shared contents.

79. The method of claim 27, wherein enabling user to select one or more parts of keyword(s) or key phrase(s) for creating, generating & updating one or more keyword(s) or key phrase(s).

80. The method of claim 27, wherein parts of keyword(s) or key phrase(s) comprises one or more grammar part(s), keywords, categories, taxonomies, groups, types, items, objects, nodes, named entities, type of purposes, requirements, activities, actions, transactions, events, status, actors, profile properties, metadata, data, fields & values, rules, conditions, criteria & programming syntax, phases, words, sentences, templates, tags, ontology, semantic syntax, Boolean Operators (+, −, >, <, =etc.), commands, types of syntax including structured query language (SQL), user associate contacts, connections, nodes, named entities, selected one or more fields and associate values, date & time (ranges, from-to, calendar, schedule.

81. The method of claim 27, wherein enabling user to select one or more posts or one or more types of posts or one or more types of or one or more exact, broader or narrow matched or phrase matched or similar keywords or key phrases or categories or taxonomies specific posts related participations including chat with followers, viewers & providers, receive questions for providing answers, review or edit or update or rectify posts, report, provide ratings, likes or dislikes & comments, participate in collaborative enhancement of suggested topics, participate in real-time conversations, provide structure information, add curated or searched or edited contents from one or more sources and provide requested or suggested or instructed or presented topic or query or subject specific information or contents and provide participation date and time, scheduling, presence information or availability user & one or more types of participations.

82. A method comprising:
enabling user to draft, prepare, search, select, input, capture, record, author, compose, edit, update one or more or group(s) of keyword(s) or key phrase(s) specific one or more types of contents;
enabling user to real-time or near real-time post, send, publish, update, export, share, synchronize, advertise, broadcast, send, provide & present one or more types of contents;
enabling users to real-time or near real-time consume, receive, store, import, subscribe, follow, search, retrieve, select & view one or more or group(s) of keyword(s) or key phrase(s) specific contextual or updated one or more types of contents.

83. The method of claim 82, wherein enabling user to draft, prepare, search, select, input, capture, record, author, compose, edit, update and post, send, publish, update, export, share, synchronize, advertise, broadcast, send, provide & present and consume, receive, store, import, subscribe, follow, search, retrieve, select & view one or more or group(s) of keyword(s) or key phrase(s) specific one or more types of contents from one or more web sites, domains, web pages, applications, clients including smart client applications, servers, devices, databases, networks via APIs, web services and one or more types of communication interface.

84. The method of claim 82, wherein one or more types of contents comprises message, blog, article, news, survey, data, search results, questions and associate answers, structured contents including database, fields & associate values, one or more types of controls, forms, contents input, select, compose, update via applications, widgets, custom forms & interfaces, one or more types of media including text, link, audio, image, photo, video, voice, voice to text, text detected from images or videos, file, document, application, object, user profile, named entities, keywords, phrases, named entities, locations, nodes, nodes of network, categories, taxonomies, ontology, metadata and any combination thereof.

85. The method of claim 82, wherein users comprises sender, receiver, posting user, sharing user, user(s) or group(s) of users of social network, administrator, editor, author, group(s), service provider(s), follower, following user, connected user, user connections, connections of connections, publisher, subscriber, advertiser, broadcaster, viewer, audience, provider, presenter, database, storage medium, server, application, web site, web page, web service, repository, device, network and auto sources, destinations, consumers & providers.

86. The method of claim 82, wherein enabling user to search, match, browse & select, highlight, select from suggested. select from presented, select from highlighted, share, suggest, update, edit, remove, sort, rank or rate, list or group or categories, bookmark, draft, identify, verify, validate, import, merge, divide, generate & create one or more keyword(s) or key phrase(s).

87. The method of claim 82, wherein auto present or suggest one or more or group(s) or list(s) of keyword(s) or key phrase(s).

88. The method of claim 87, wherein auto present or suggest one or more or group(s) or list(s) of keyword(s) or key phrase(s) based on based on date, time, user activities, actions, events, transactions, logs, interactions, senses, locations, check-in places, updates, status, current trends, connections, connected users' data, user profile, preferences, privacy settings, shared data & any combination thereof.

89. The method of claim 82, wherein enabling user to view, store, edit, update, process, sort, filter, bookmark, rank or rate, like, dislike, report, reply, ignore, provide comments, follow source, follow followers, viewers and following users of source & share contents.

90. The method of claim 82, wherein enabling user to receive, search, request, follow & view one or more user selected keywords or key phrases or categories or taxonomies specific contents, wherein contents comprising contents posted by users of network under one or more user(s) created one or more keywords or key phrases or categories or taxonomies.

91. The method of claim 82, wherein enabling user to posts contents under one or more user created, select users of network created one or more keywords or key phrases or categories or taxonomies.

92. The method comprising:
enabling user(s) to send request(s), wherein request(s) comprising requesting one or more keyword(s) or key phase(s) specific real-time contents from provider(s);
storing request(s);
searching & matching request(s) specific contextual real-time provider(s) of contents;
real-time presenting or sending request(s) to contextual provider(s) of contents; and
enabling provider(s) to real-time post or share or send or update request(s) specific contents.

93. The method of claim 92, wherein enabling request(s) receiver(s) to accept, make request as pending, ignore or decline request(s).

94. The method of claim 92, wherein searching & matching request(s) specific contextual provider(s) based on keyword(s) or key phrase(s) specific content providers or posting users or publishers, locations, matched user profile & user data, user logs, activities, actions, interactions, behavior, senses, events, transactions, status, updates, connections, shared contents, presence information, locations, check-in places.

95. The method of claim 92, wherein enabling request(s) to request one or more types of contents.

96. The method of claim 92, wherein one or more types of contents comprising advertisements, news, blogs, search results, questions, answers, message, communication or conversation, collaborative contents, availability, posts, shared contents, profile, fields and associate values, domain or subject related forms specific structured contents, location, products, services, lists, comments, reviews, suggestions, thoughts, one or more types of media including text, photo, video, audio, image, link, document or file, application, object, interface, controls, widget, web service, structured contents via one or more types of forms, custom forms, wizards, interactive forms & interfaces.

97. The method of claim 92, wherein adding points to providers of keyword(s) or key phase(s) specific real-time contents.

98. The method of claim 92, wherein deducting points from requester(s) of keyword(s) or key phase(s) specific real-time contents.

99. The method of claim 92, wherein auto sending one or more auto identified, suggested, selected, sensed or detected requests.

100. The method of claim 92, wherein auto sending one or more auto identified, suggested, selected, sensed or detected requests based on date, time, user activities, actions, events, transactions, logs, interactions, senses, locations, check-in places, updates, status, current trends, connections, connected users' data, user profile, preferences, privacy settings, shared data & any combination thereof.

101. The method of claim 92, wherein enabling user to program sending or posting of request(s) or requesting and receiving requested one or more keyword(s) or key phase(s) specific real-time contents from provider(s).

102. A method comprising:
auto identifying, determining, searching, matching, suggesting, selecting, detecting & presenting one or more keyword(s) and key phrase(s) related to user or enabling user select, highlight, select highlighted, select suggested, select from web page or document, input, edit, update, select via auto-fill or auto-complete one or more keyword(s) and key phrase(s); and
presenting keyword(s) and key phrase(s) specific real-time user generated or posted or provided or presented or published or shared or updated contextual one or more types of contents.

103. The method of claim 102, wherein auto identifying, determining, searching, matching, suggesting, selecting, detecting & presenting one or more keyword(s) and key phrase(s) based on user profile, user data, user logs, activities, actions, interactions, behavior, senses, events, transactions, status, updates, connections, shared contents, presence information, locations, check-in places, generally useful, popular, current topics, news & trends,

104. The method of claim 102, wherein presenting keyword(s) and key phrase(s) specific contents comprising contents posted by users, keyword(s) and key phrase(s) specific publishers or posting or sharing users specific contents including included, excluded, broader match, narrow match, exact match, phrase match contents, search results, contents from databases or sources, past posted or shared or publishes contents, contents suggested by contacts, followers, viewers & platform or server, auto select, suggest & update preferences specific contents including categories, taxonomies, keyword(s) and key phrase(s), get auto contents or feeds from contacts or selected contacts & connections, advertisements & news to use contents, contextual contents from one or more selected contacts & connections, followers, viewers.

105. The method of claim 102, wherein auto send said auto identified, determined, searched, matched, suggested, selected, detected & presented one or more keyword(s) and key phrase(s) specific content request(s) to provider(s); storing request(s); searching & matching request(s) specific contextual real-time provider(s) of contents; real-time presenting or sending request(s) to contextual provider(s) of contents; and enabling provider(s) to real-time post or share or send or update request(s) specific contents.

106. The method of claim 102, wherein keyword(s) comprises one or more or group(s) of exact, matched, broader matched, alternative, similar keywords, sequence of words or characters, categories, sub-categories, taxonomies, names, named entities, nodes, items, list, locations, key phrases, ontology, semantic syntax, sentence.

107. The method of claim 102, wherein presenting categories or taxonomy wise directories of keyword(s) key phrase(s) specific real-time user generated or posted or provided or presented or published or shared or updated contextual one or more types of contents.

108. The method of claim 27, wherein adding points to user account based on number of posts, number of daily posts, type or name of keyword(s) or key phrase(s) under which user posts, number of likes by other users, number of comments by other users, number & weight of ratings by other users, number of followers, number of viewers, purchase of points, number of following users, number of followed keywords by user, number of posts received or viewed by user, number of likes, dislikes, reports, re-sharing, referring, ratings, comments provided by user, number of replies and additional instructed or suggested content sharing on posts provided by users.

109. The method of claim 27, wherein deducting points to user account based on non-posting of particular number of posts for particular duration, number of dis-likes, number of negative ratings & number of reports by other users.

110. The method of claim 27, wherein based on number of points providing posting user priority in posting posts to more viewing user in more prominent place or rank of listing of posts.

111. A method comprising:
enabling user(s) to search, match, browse, select, set, apply & update one or more categories and taxonomies to follow posted contents related to or posted under said one or more categories and taxonomies by providers or posting users;
enabling user(s) to post contents;
store contents;
determining or updating one or more categories and taxonomies of posted contents;
matching followed categories and taxonomies of user(s) with said determined categories and taxonomies of said posted contents; and
presenting followed one or more categories and taxonomies specific contents to categories and taxonomies followers.

112. The method of claim 111, wherein enabling viewing user to follow posted content associate source.

113. The method of claim 111, wherein enabling viewing user to follow posted content associate one or more followers of source(s).

114. The method of claim 111, wherein enabling viewing user to follow posted content associate one or more viewers.

115. The method of claim 111, wherein enabling user to follow one or more sources of received posts.

116. The method of claim 111, wherein enabling user to schedule posting and schedule presenting.

117. The method of claim 111, wherein enabling user to hide or show posts, un-follow one or more categories & taxonomies and un-follow source(s) of post(s).

118. The method of claim 111, wherein present posts real-time up-to set particular period of time by sending or posting user.

119. The method of claim 111, wherein present received contents based on date& time, preferences of order of followed categories and taxonomies, most liked, rated & commented posts and/or sources, applied sorting order including sources wise, location wise, categories or taxonomies wise, applied filter criteria.

120. The method of claim 111, wherein enabling user to refer or share one or more posts, sources, followed categories or taxonomies to one or more contacts or connections of user for enabling them to view shared post(s) and/or follow source(s) of post(s) and/or follow one or more categories or taxonomies.

121. The method of claim 27, wherein enabling user to select one or more keywords, key phrases, categories or taxonomies for posting one or more types of posts or shared contents.

122. The method of claim 27, wherein enabling user to select or un-select selected or accept requested & invited one or more types of participation or contribution or content or management related activities, actions, events, collaboration, communication, interactions, transactions, tasks, workflow and associate settings including participation related to one or more keywords, key phrases, categories or taxonomies, participation date & time or scheduling, search, match, select, install, subscribe, make payment, select from suggested & register one or more associate contextual applications, services, data or contents, widgets, interactive forms & interfaces.

123. The method of claim 122 wherein contextually presenting said selected types of participation or contribution or content or management related activities, actions, events, collaboration, communication, interactions, transactions, tasks, workflow of one or more users of network in/within/at/on one or more users' profiles, posts or shared contents, one or more keywords, key phrases, categories or taxonomies, list of followers, lists, viewers, following users, contacts, requests and one or more types of prominent places of web page, web site, applications, widgets, web services & interfaces.

124. The method of claim 122, wherein presenting, suggesting, allowing, notifying to user said selected types of participation or contribution or content or management related activities, actions, events, collaboration, communication, interactions, transactions, tasks, workflow specific posts or shared contents or requests or invitations or allowance or questions from other users of network including followers, viewers, following users, contacts to enable to provide or conduct or participate in one or more types of participation or contribution or content or management related activities, actions, events, collaboration, communication, interactions, transactions, tasks, workflow.

125. The method of claim 122, wherein enabling user to provide or fulfill or take or execute or conduct said selected one or more types of participation or contribution or content or management related activities, actions, events, collaboration, communication, interactions, transactions, tasks, workflow.

126. The method of claim 122, wherein enabling users to ask, suggest, allow, alert, notify, remember, request, invite for & rate, rank, like, dislike, comment said one or more participated users and/or one or more types of participation or contribution or content or management related activities, actions, events, collaboration, communication, interactions, transactions, tasks, workflow of users.

127. A system comprising:
user(s) is enable to input, select, edit, update & verify one or more keyword(s), wherein keyword enables posting users of network to select verified keywords at the time of posting contents under said keyword;
user(s) is enable to follow one or more keyword(s) for real-time receiving followed keyword(s) related posted contents;
user(s) is enable to post contents under one or more keyword(s);
a storage medium to store contents and associate keyword(s);
a module is configure to match followed keyword(s) of user(s) with said posted contents associate keyword(s); and
present followed keyword(s) specific contents to keyword(s) follower(s).

128. The system of claim 127, wherein keyword(s) comprises one or more or group(s) of exact, matched, broader matched, alternative, similar keywords, sequence of words or characters, categories, sub-categories, taxonomies, names, named entities, nodes, items, locations, key phrases, ontology, semantic syntax, sentence.

129. The system of claim 127, wherein keyword matched based on exact match, broader match, narrow match, phrase match and similar matches.

130. The system of claim 127, wherein enable viewing user to follow one or more keyword(s) associate followers.

131. The system of claim 127, wherein enable viewing user to follow posted content associate viewers.

132. The system of claim 127, wherein enable viewing user to follow posted content source(s).

133. The system of claim 127, wherein enable viewing user to follow one or more followed keyword(s) related similar or alternative or matched other keyword(s).

134. The system of claim 127, wherein enable viewing user to ignore one or more received posted contents associate keyword(s).

135. The system of claim 127, wherein enable viewing user to ignore one or more received posted contents associate source(s).

136. The system of claim 127, wherein enable users to create and update list(s) of keyword(s).

137. The system of claim 136, wherein enable users to follow said one or more list(s) of keyword(s).

138. The system of claim 137, wherein enable users to follow said one or more keywords from said one or more list(s) of keyword(s).

139. The system of claim 137, wherein enable users to follow said one or more followers of said one or more list(s) of keyword(s).

140. The system of claim 139, wherein create group(s) based on posting users and/or followers of similar types of keywords including exact, broader match, phrase match, alternative, related meaning associate keywords, rank, number of likes & comments and ratings, similar profiles, activities, actions, events, transactions, locations, check-in places, updates, status, presence information, connections, connected users' data and any combination thereof.

141. The system of claim 140, wherein enable or instruct or suggest said group(s) to share contents, enhance or expand posts, update posts, converse with each other.

142. The system of claim 127, wherein enable users to share and refer one or more keywords for enabling receiving user to follow said shared or referred keywords.

143. The system of claim 127, wherein enable posting users to target post to viewing users based on one or more criteria including locations, languages, IP addresses, user profile data or fields including age range, income range, education qualifications, user attributes including height, weight, color & like, cast, interests, preferences, privacy settings, rules, date & time, names, contacts, named entities, gender, employment type, business type, networks, type of user's activities, actions, events, senses, transactions, behavior, status and one or more or group(s) or list(s) of exact, broader matched, phrase match & similar keywords, key phrases, named entities, categories, & taxonomies associate followers & viewers and any combination thereof.

144. The system of claim 127, wherein enable one or more keyword(s) specific posting users to follow each other and create group(s).

145. The system of claim 144, wherein enable to collaboratively draft, compose, input, edit, admin, update one or more posts and share contents.

146. The system of claim 127, wherein enabling user to schedule posting and schedule presenting.

147. The system of claim 127, wherein enable user to select, start, pause, re-start, hide, show & stop or un-follow receiving of followed keyword(s) specific contents.

148. The system of claim 127, wherein enable user to search, match, select and invite users of network and/or searched posts or contents associate sources, viewers, followers & following users to follow or connect user(s).

149. The system of claim 127, wherein enable user to search, match, select posted contents and follow selected posted content associate keyword(s).

150. The system of claim 127, wherein present to user matched & updated users related to user.

151. The system of claim 150, wherein present to user matched & updated users related to user based on preferences, privacy settings, rank or rating of user, number of current points, purchasing of target or contextual viewers, user connections, followers, following users, viewers, related or contextual exact, broader matched, phrase match, similar & matched keyword specific posting users, groups, followers, following users & viewers, profile, shared contents, user activities, logs, actions, events, interactions, senses, transactions, locations, checked-in places, behavior.

152. The system of claim 150, wherein enable user to search, match, browse, select users from presented matched & updated users related to user for inviting them to become follower of each other by accepting invitations.

153. The system of claim 152, wherein enable user to apply settings for automatically un-follow mutually followed users when mutually followed users un-follow user(s).

154. The system of claim 127, wherein enable user to follow one or more selected keywords of one or more source(s) or user(s) or posting user(s) or publisher(s) or broadcaster(s).

155. The system of claim 127, wherein enable user to follow broader or parent keywords which includes child or child of child up-to tree like presented number of depths or set or collection or group(s) or list(s) of keywords including similar, related, curated, contextual, ontologically & semantically or meaning wise related keywords.

156. The system of claim 127, wherein enable user to create list(s) of keywords including parent keyword(s) and associate child keyword(s), practically or semantically or ontologically or meaning wise related.

157. The system of claim 127, wherein verify keyword including check language, availability, meaning, similar, alternate, existence of keyword(s) and phrase(s).

158. The system of claim 157, wherein verification task assign to one or more ranked or verified users of network, administrator, verify & validate via software, web services, databases, online web sites, search engines.

159. The system of claim 127, wherein auto identify, attach, associate, relate, store, present, update one or more keywords, phrases, named entities, nodes, nodes of network, categories, taxonomies, ontology, metadata related to drafted, saved, edited, presented, selected, updated, posting or posted contents.

160. The system of claim 127, wherein present, update, identify suggested one or more keywords, phrases, named entities, nodes, nodes of network, categories, taxonomies, ontology, metadata related to drafted, saved, edited, presented, selected, updated, posting or posted contents.

161. The system of claim 160, wherein said post specific suggested keywords, phrases, named entities, nodes, nodes of network, categories, taxonomies, ontology, metadata are based on contents of post or drafted or updated or edited or presented or shared contents, meaning, similar or related or contextual, suggested by connected users, user profile, user data, connections, followers, following users, viewers, connected users' data, user logs, activities, actions, events, transactions, interactions, senses, locations, check-in places, updates, status, current trends, preferences, privacy settings, shared data & any combination thereof.

162. The system of claim 161, wherein enable user to search, match, import, ask, browse, filter, select one or more suggested keywords for posting contents under said selected one or more keywords, phrases, named entities, nodes, nodes of network, categories, taxonomies, ontology, metadata.

163. The system of claim 127, wherein enable user to select one or more keywords, phrases, named entities, nodes, nodes of network, categories, taxonomies, ontology, metadata related to drafted, saved, edited, presented, selected, updated, posting or posted contents.

164. The system of claim 127, wherein enable user to create, collaboratively create & update one or more keywords, phrases, named entities, nodes, nodes of network, categories, taxonomies, ontology, metadata.

165. The system of claim 127, wherein enable to receive, store, present, update, associate contextual, updated & real-time user generated contents or user posted contents to one or more keywords, phrases, named entities, nodes, nodes of network, categories, taxonomies, ontology, metadata related to one or more types of contents via APIs.

166. The system of claim 127 or 165, wherein enable user to select or select from highlighted one or more keywords, phrases, named entities, nodes, nodes of network, categories, taxonomies, ontology, metadata from presented, searched, received one or more types of contents and presenting said selected or highlighted one or more keywords, phrases, named entities, nodes, nodes of network, categories, taxonomies, ontology, metadata specific user posted or updated contents.

167. The system of claim 165 or 166, wherein contents comprises contents of web page(s) or web site(s), drafted or edit contents, contents of application(s) or database(s) and one or more types of media including text, link, audio, image, photo, video, voice, voice to text, text detected from images or videos, file, document, application, object, user profile, named entities, keywords, phrases, named entities, locations, nodes, nodes of network, categories, taxonomies, ontology, metadata.

168. The system of claim 127, wherein enable user to post contents to followers, viewers & connected users without selected one or more keywords, phrases, named entities, nodes, nodes of network, categories, taxonomies, ontology, metadata.

169. The system of claim 127, wherein suggest or indicate user what to post including suggest or present or update one or more types of contents, invited for collaboratively drafted topic or subject or keyword, topics, trends, news, links, links of sources of contents including web sites, databases, past shared contents, contents from network, social network, user & connected users' profile(s) & related data.

170. The system of claim 169, wherein suggestion based on user drafted or inputted or selected or edited or updated or presented contents.

171. The system of claim 169, wherein suggestion based on based on user profile including fields and associate values like qualification, age, gender, location, type & name of employment or college or school & interests, user data, connections, followers, following users, viewers, connected users' data, user logs, activities, actions, events, transactions, interactions, senses, locations, check-in places, updates, status, current trends, preferences, privacy settings, shared data & any combination thereof.

172. The system of claim 127, wherein enable to verified as well as anonymous user accounts, enterprise accounts, posts or shared contents, sources, publishers, following related keywords, key phrases, categories, taxonomies, lists, viewers, followers, following users, contacts or connections, provider of comments, ratings, & likes.

173. The system of claim 127, wherein enable user to search, match, select, select from presented or suggested or auto matched, purchase, update, and customize structured contents for posting structured contents.

174. The system of claim 127, wherein structured contents or resources comprises domain or subject or keyword(s) or key pharse(s) specific forms, wizards, templates, fields and/or associate values, applications, custom forms, interfaces, widgets, set of controls, links, objects, functions, features, user actions, pre-created and/or customizable forms including profile, job requirements, job profile, survey forms, advertisements, group deals.

175. The system of claim 127, wherein enable user to import, export, store & index to database, data mine, download, upload, subscribe, submit or re-submit filled forms, participate with interactive survey forms, follow, view, sort, filter, rank, rate, bookmark, group, list, categories, search & match based on one or more criteria, compare, calculate, process, analyze structured contents or resources.

176. The system of claim 127, wherein suggest or instruct viewing users or followers to provide one or more types of structured or unstructured further details on one or more posts or shared contents.

177. The system of claim 176, wherein one or more types of structured or unstructured further details on one or more posts or shared contents comprises questions, answers, availability including locations, address, maps & directions, features, climate, price, comparison, similar posts or contents, related keywords, key phrases, categories, taxonomies & metadata, types of contents, properties, attributes, pre-created, presents & customized fields and associate values, edited or updated version of contents, enhancement of contents including related news, blogs, search results, links, photos, videos and like, one or more types of user actions including like, dis-like, buy, sell, purchased, interested, suggest, refer, bookmark, response, comments, rank, rate, vote, listen, play, recipe, emoticons.

178. The system of claim 127, wherein enable keyword(s) or key phrase(s) specific viewers & followers to view real-time updated or posted or provided and past posts and shared contents.

179. The system of claim 127, wherein enable user to select one or more parts of keyword(s) or key phrase(s) for creating, generating & updating one or more keyword(s) or key phrase(s).

180. The system of claim 127, wherein parts of keyword(s) or key phrase(s) comprises one or more grammar part(s), keywords, categories, taxonomies, groups, types, items, objects, nodes, named entities, type of purposes, requirements, activities, actions, transactions, events, status, actors, profile properties, metadata, data, fields & values, rules, conditions, criteria & programming syntax, phases, words, sentences, templates, tags, ontology, semantic syntax, Boolean Operators (+, −, >, <, =etc.), commands, types of syntax including structured query language (SQL), user associate contacts, connections, nodes, named entities, selected one or more fields and associate values, date & time (ranges, from-to, calendar, schedule.

181. The system of claim 127, wherein enabling user to select one or more posts or one or more types of posts or one or more types of or one or more exact, broader or narrow matched or phrase matched or similar keywords or key phrases or categories or taxonomies specific posts related participations including chat with followers, viewers & providers, receive questions for providing answers, review or edit or update or rectify posts, report, provide ratings, likes or dislikes & comments, participate in collaborative enhancement of suggested topics, participate in real-time conversations, provide structure information, add curated or searched or edited contents from one or more sources and provide requested or suggested or instructed or presented topic or query or subject specific information or contents and provide participation date and time, scheduling, presence information or availability user & one or more types of participations.

182. A system comprising:
user is enable to draft, prepare, search, select, input, capture, record, author, compose, edit, update one or more or group(s) of keyword(s) or key phrase(s) specific one or more types of contents;
user is enable to real-time or near real-time post, send, publish, update, export, share, synchronize, advertise, broadcast, send, provide & present one or more types of contents;
user is enable to real-time or near real-time consume, receive, store, import, subscribe, follow, search, retrieve, select & view one or more or group(s) of keyword(s) or key phrase(s) specific contextual or updated one or more types of contents.

183. The system of claim 182, wherein enable user to draft, prepare, search, select, input, capture, record, author, compose, edit, update and post, send, publish, update, export, share, synchronize, advertise, broadcast, send, provide & present and consume, receive, store, import, subscribe, follow, search, retrieve, select & view one or more or group(s) of keyword(s) or key phrase(s) specific one or more types of contents from one or more web sites, domains, web pages, applications, clients including smart client applications, servers, devices, databases, networks via APIs, web services and one or more types of communication interface.

184. The system of claim 182, wherein one or more types of contents comprises message, blog, article, news, survey, data, search results, questions and associate answers, structured contents including database, fields & associate values, one or more types of controls, forms, contents input, select, compose, update via applications, widgets, custom forms & interfaces, one or more types of media including text, link, audio, image, photo, video, voice, voice to text, text detected from images or videos, file, document, application, object, user profile, named entities, keywords, phrases, named entities, locations, nodes, nodes of network, categories, taxonomies, ontology, metadata and any combination thereof.

185. The system of claim 182, wherein users comprises sender, receiver, posting user, sharing user, user(s) or group(s) of users of social network, administrator, editor, author, group(s), service provider(s), follower, following user, connected user, user connections, connections of connections, publisher, subscriber, advertiser, broadcaster, viewer, audience, provider, presenter, database, storage medium, server, application, web site, web page, web service, repository, device, network and auto sources, destinations, consumers & providers.

186. The system of claim 182, wherein enable user to search, match, browse & select, highlight, select from suggested. select from presented, select from highlighted, share, suggest, update, edit, remove, sort, rank or rate, list or group or categories, bookmark, draft, identify, verify, validate, import, merge, divide, generate & create one or more keyword(s) or key phrase(s).

187. The system of claim 182, wherein auto present or suggest one or more or group(s) or list(s) of keyword(s) or key phrase(s).

188. The system of claim 187, wherein auto present or suggest one or more or group(s) or list(s) of keyword(s) or key phrase(s) based on based on date, time, user activities, actions, events, transactions, logs, interactions, senses, locations, check-in places, updates, status, current trends, connections, connected users' data, user profile, preferences, privacy settings, shared data & any combination thereof.

189. The system of claim 182, wherein enable user to view, store, edit, update, process, sort, filter, bookmark, rank or rate, like, dislike, report, reply, ignore, provide comments, follow source, follow followers, viewers and following users of source & share contents.

190. The system of claim 182, wherein enable user to receive, search, request, follow & view one or more user selected keywords or key phrases or categories or taxonomies specific contents, wherein contents comprising contents posted by users of network under one or more user(s) created one or more keywords or key phrases or categories or taxonomies.

191. The system of claim 182, wherein enable user to posts contents under one or more user created, select users of network created one or more keywords or key phrases or categories or taxonomies.

192. The system comprising:
user(s) is enable to send request(s), wherein request(s) comprising requesting one or more keyword(s) or key phase(s) specific real-time contents from provider(s);
a storage medium to store request(s);
a module is configure to search & match request(s) specific contextual real-time provider(s) of contents;
a module is configure to real-time present or send request(s) to contextual provider(s) of contents; and
provider(s) is/are enable to real-time post or share or send or update request(s) specific contents.

193. The system of claim 192, wherein enable request(s) receiver(s) to accept, make request as pending, ignore or decline request(s).

194. The system of claim 192, wherein search & match request(s) specific contextual provider(s) based on keyword(s) or key phrase(s) specific content providers or posting users or publishers, locations, matched user profile & user data, user logs, activities, actions, interactions, behavior, senses, events, transactions, status, updates, connections, shared contents, presence information, locations, check-in places.

195. The system of claim 192, wherein enable request(s) to request one or more types of contents.

196. The system of claim 192, wherein one or more types of contents comprises advertisements, news, blogs, search results, questions, answers, message, communication or conversation, collaborative contents, availability, posts, shared contents, profile, fields and associate values, domain or subject related forms specific structured contents, location, products, services, lists, comments, reviews, suggestions, thoughts, one or more types of media including text, photo, video, audio, image, link, document or file, application, object, interface, controls, widget, web service, structured contents via one or more types of forms, custom forms, wizards, interactive forms & interfaces.

197. The system of claim 192, wherein add points to providers of keyword(s) or key phase(s) specific real-time contents.

198. The system of claim 192, wherein deduct points from requester(s) of keyword(s) or key phase(s) specific real-time contents.

199. The system of claim 192, wherein auto send one or more auto identified, suggested, selected, sensed or detected requests.

200. The system of claim 192, wherein auto send one or more auto identified, suggested, selected, sensed or detected requests based on date, time, user activities, actions, events, transactions, logs, interactions, senses, locations, check-in places, updates, status, current trends, connections, connected users' data, user profile, preferences, privacy settings, shared data & any combination thereof.

201. The system of claim 192, wherein enable user to program sending or posting of request(s) or requesting and receiving requested one or more keyword(s) or key phase(s) specific real-time contents from provider(s).

202. A system comprising:
auto identify, determine, search, match, suggest, select, detect & present one or more keyword(s) and key phrase(s) related to user or enabling user select, highlight, select highlighted, select suggested, select from web page or document, input, edit, update, select via auto-fill or auto-complete one or more keyword(s) and key phrase(s); and
present keyword(s) and key phrase(s) specific real-time user generated or posted or provided or presented or published or shared or updated contextual one or more types of contents.

203. The system of claim 202, wherein auto identify, determine, search, match, suggest, select, detect & present one or more keyword(s) and key phrase(s) based on user profile, user data, user logs, activities, actions, interactions, behavior, senses, events, transactions, status, updates, connections, shared contents, presence information, locations, check-in places, generally useful, popular, current topics, news & trends,

204. The system of claim 202, wherein present keyword(s) and key phrase(s) specific contents comprises contents posted by users, keyword(s) and key phrase(s) specific publishers or posting or sharing users specific contents including included, excluded, broader match, narrow match, exact match, phrase match contents, search results, contents from databases or sources, past posted or shared or publishes contents, contents suggested by contacts, followers, viewers & platform or server, auto select, suggest & update preferences specific contents including categories, taxonomies, keyword(s) and key phrase(s), get auto contents or feeds from contacts or selected contacts & connections, advertisements & news to use contents, contextual contents from one or more selected contacts & connections, followers, viewers.

205. The system of claim 202, wherein auto send said auto identified, determined, searched, matched, suggested, selected, detected & presented one or more keyword(s) and key phrase(s) specific content request(s) to provider(s); storing request(s); searching & matching request(s) specific contextual real-time provider(s) of contents; real-time presenting or sending request(s) to contextual provider(s) of contents; and enabling provider(s) to real-time post or share or send or update request(s) specific contents.

206. The system of claim 202, wherein keyword(s) comprises one or more or group(s) of exact, matched, broader matched, alternative, similar keywords, sequence of words or characters, categories, sub-categories, taxonomies, names, named entities, nodes, items, list, locations, key phrases, ontology, semantic syntax, sentence.

207. The system of claim 202, wherein present categories or taxonomy wise directories of keyword(s) key phrase(s) specific real-time user generated or posted or provided or presented or published or shared or updated contextual one or more types of contents.

208. The system of claim 127, wherein add points to user account based on number of posts, number of daily posts, type or name of keyword(s) or key phrase(s) under which user posts, number of likes by other users, number of comments by other users, number & weight of ratings by other users, number of followers, number of viewers, purchase of points, number of following users, number of followed keywords by user, number of posts received or viewed by user, number of likes, dislikes, reports, re-sharing, referring, ratings, comments provided by user, number of replies and additional instructed or suggested content sharing on posts provided by users.

209. The system of claim 127, wherein deduct points to user account based on non-posting of particular number of posts for particular duration, number of dis-likes, number of negative ratings & number of reports by other users.

210. The system of claim 127, wherein based on number of points provide posting user priority in posting posts to more viewing user in more prominent place or rank of listing of posts.

211. A system comprising:
user(s) is/are enable to search, match, browse, select, set, apply & update one or more categories and taxonomies to follow posted contents related to or posted under said one or more categories and taxonomies by providers or posting users;
user(s) is/are enable to post contents;
a storage medium to store contents;
a module is configure to determine or update one or more categories and taxonomies of posted contents;
a module is configure to match followed categories and taxonomies of user(s) with said determined categories and taxonomies of said posted contents; and
present followed one or more categories and taxonomies specific contents to categories and taxonomies followers.

212. The system of claim 211, wherein enable viewing user to follow posted content associate source.

213. The system of claim 211, wherein enable viewing user to follow posted content associate one or more followers of source(s).

214. The system of claim 211, wherein enable viewing user to follow posted content associate one or more viewers.

215. The system of claim 211, wherein enable user to follow one or more sources of received posts.

216. The system of claim 211, wherein enable user to schedule posting and schedule presenting.

217. The system of claim 211, wherein enable user to hide or show posts, un-follow one or more categories & taxonomies and un-follow source(s) of post(s).

218. The system of claim 211, wherein present posts real-time up-to set particular period of time by sending or posting user.

219. The system of claim 211, wherein present received contents based on date& time, preferences of order of followed categories and taxonomies, most liked, rated & commented posts and/or sources, applied sorting order including sources wise, location wise, categories or taxonomies wise, applied filter criteria.

220. The system of claim 211, wherein enable user to refer or share one or more posts, sources, followed categories or taxonomies to one or more contacts or connections of user for enabling them to view shared post(s) and/or follow source(s) of post(s) and/or follow one or more categories or taxonomies.

221. The system of claim 127, wherein enable user to select one or more keywords, key phrases, categories or taxonomies for posting one or more types of posts or shared contents.

222. The system of claim 127, wherein enable user to select or un-select selected or accept requested & invited one or more types of participation or contribution or content or management related activities, actions, events, collaboration, communication, interactions, transactions, tasks, workflow and associate settings including participation related to one or more keywords, key phrases, categories or taxonomies, participation date & time or scheduling, search, match, select, install, subscribe, make payment, select from suggested & register one or more associate contextual applications, services, data or contents, widgets, interactive forms & interfaces.

223. The system of claim 222, wherein contextually present said selected types of participation or contribution or content or management related activities, actions, events, collaboration, communication, interactions, transactions, tasks, workflow of one or more users of network in/within/at/on one or more users' profiles, posts or shared contents, one or more keywords, key phrases, categories or taxonomies, list of followers, lists, viewers, following users, contacts, requests and one or more types of prominent places of web page, web site, applications, widgets, web services & interfaces.

224. The system of claim 222, wherein present, suggest, allow, notify to user said selected types of participation or contribution or content or management related activities, actions, events, collaboration, communication, interactions, transactions, tasks, workflow specific posts or shared contents or requests or invitations or allowance or questions from other users of network including followers, viewers, following users, contacts to enable to provide or conduct or participate in one or more types of participation or contribution or content or management related activities, actions, events, collaboration, communication, interactions, transactions, tasks, workflow.

225. The system of claim 222, wherein enable user to provide or fulfill or take or execute or conduct said selected one or more types of participation or contribution or content or management related activities, actions, events, collaboration, communication, interactions, transactions, tasks, workflow.

226. The system of claim 222, wherein enable users to ask, suggest, allow, alert, notify, remember, request, invite for & rate, rank, like, dislike, comment said one or more participated users and/or one or more types of participation or contribution or content or management related activities, actions, events, collaboration, communication, interactions, transactions, tasks, workflow of users.
